(19) United States
(12) Patent Application Publication
(10) Pub. No.: US 2025/0140921 A1
(43) Pub. Date: May 1, 2025

(54) IONIC LIQUID AND COMPOSITE ELECTROLYTE

(71) Applicants: SUMITOMO CHEMICAL COMPANY, LIMITED, Tokyo (JP); Kyoto University, Kyoto (JP); NATIONAL UNIVERSITY CORPORATION TOTTORI UNIVERSITY, Tottori (JP)

(72) Inventors: Hideto NAKAJIMA, Niihama-shi, Ehime (JP); Satoshi SHIMANO, Kyoto-shi, Kyoto (JP); Toshiki NOKAMI, Tottori-shi, Tottori (JP)

(21) Appl. No.: 18/687,728

(22) PCT Filed: Sep. 2, 2022
(86) PCT No.: PCT/JP2022/033191

§ 371 Date: Feb. 28, 2024

(30) Foreign Application Priority Data
Sep. 2, 2021 (JP) 2021-143472
Sep. 2, 2022 (JP) 2022-140138

(51) Int. Cl. H01M 10/0567; H01G 11/62; H01M 10/0525

(52) U.S. Cl. CPC H01M 10/0567; H01G 11/62; H01M 10/0525; H01M 2300/0091

(57) ABSTRACT

A dicationic ionic liquid contains a cation having two moieties each containing a heteroatom having a positive formal charge, and a linking group bonding to each of the heteroatoms of the two moieties to link the two moieties, in which the linking group is represented by a formula: —CR¹R²OCR³R⁴CR⁵R⁶OCR⁷R⁸—.

(In the formula, R¹ to R⁸ are each a hydrogen atom, a fluorine atom, or a monovalent organic group having 1 to 20 carbon atoms.)

### TECHNICAL FIELD

The present invention relates to an ionic liquid and a composite electrolyte.

### BACKGROUND ART

In recent years, as the performance of electrochemical devices such as lithium ion batteries has improved, electrolytes used in electrochemical devices have been required to have characteristics such as a higher lithium ionic conductivity and voltage withstanding characteristics.

Ionic liquids are attracting attention as components of electrolytes (patent literature). Ionic liquids have the following useful characteristics as compared to other electrolytes. First, ionic liquids have a wider potential window and are less prone to gas generation due to solvent electrolysis, as compared to organic solvents used in conventional electrolytic solutions. In addition, in ionic liquids, an energy barrier at the interface is small, making lithium ionic conductivity favorable, whereas in solid electrolytes, the contact area between solids is small, making an energy barrier large, and lithium ionic conductivity tends to decrease.

Furthermore, the use of gel polymers in electrolytes (gel polymer electrolytes) is being examined as means to solve the problem of energy barriers of solid electrolytes. Gel polymer electrolytes tend to have improved lithium ionic conductivity as compared to solid electrolytes. However, the polymers used were flammable, and there were safety concerns. On the other hand, ionic liquids are flame retardant and are highly safe.

### CITATION LIST

### Patent Literature

[Patent Literature 1] Chinese Unexamined Patent Application Publication No. 109776423
[Patent Literature 2] Chinese Unexamined Patent Application Publication No. 110429338
[Non-Patent Literature 1]J. F. Velez et al., “Geminal pyrrolidinium and piperidinium dicationic ionic liquid electrolytes. Synthesis, characterization and cell performance in LiMn₂O₄ rechargeable lithium cells”, Journal of Power Sources, 2019, vol. 439, page 227098.

### SUMMARY OF INVENTION

### Technical Problem

However, as a result of intensive study by the inventors of the present invention, it was found that conventional electrolytes (composite electrolytes) containing an ionic liquid and a lithium salt have room for improvement in terms of lithium ion transport numbers.

The present invention has been made in view of the above-mentioned circumstances, and an object of the present invention is to provide an ionic liquid and a dicationic ionic liquid which can improve lithium ion transport numbers when used as a composite electrolyte. Another object of the present invention is to provide a composite electrolyte in which a lithium ion transport number is improved.

### Solution to Problem

An ionic liquid of the present invention is a dicationic ionic liquid containing a cation that has two moieties each containing a heteroatom having a positive formal charge, and a linking group bonding to each of the heteroatoms of the two moieties to link the two moieties, in which the linking group is represented by a formula: —CR¹R²OCR³R⁴CR⁵R⁶OCR⁷R⁸—.

(In the formula, R¹ to R⁸ are each a hydrogen atom, a fluorine atom, or a monovalent organic group having 1 to 20 carbon atoms; the organic group is represented by a formula: —R^{A}—(X—R^{B})ₙ—R^{C}; R^{A} is a covalent bond or a substituted or unsubstituted divalent hydrocarbon group; X is —O—, —S—, —C(═O)—, —C(═O)O—, or —OC(═O)—; R^{B} is a covalent bond or a substituted or unsubstituted divalent hydrocarbon group; R^{C} is a substituted or unsubstituted monovalent hydrocarbon group; and n is 0 or more, provided that 4 or more of R¹ to R⁸ are hydrogen atoms.)

It is preferable that all of R¹ to R⁸ in the above-mentioned linking group be hydrogen atoms.

It is preferable that the above-mentioned ionic liquid have a 10% weight loss temperature of 280° C. or higher when measured at a temperature rising rate of 5° C./minute.

It is preferable that in the above-mentioned ionic liquid, the above-mentioned two moieties have mutually different chemical structures.

An ionic liquid of the present invention may be an ionic liquid in which, when a composite electrolyte which contains the ionic liquid and a lithium salt and in which a concentration of the lithium salt is 0.5 mol/kg in terms of lithium ions is prepared, a ratio expressed by the following expression for the composite electrolyte at 25° C. is 10% or more. It is preferable that the ionic liquid be a dicationic ionic liquid.

Iₗᵢₘ/Iᵢₙᵢ Expression:

(In the expression, Iₗᵢₘ is a limiting current density of the above-mentioned composite electrolyte, and when a constant voltage is applied to the composite electrolyte at a voltage value at which a current density first reaches the limiting current density, Iᵢₙᵢ is a current density at 1 second after start of application of the constant voltage.)

It is preferable that an upper limit of a potential window of the above-mentioned ionic liquid be 2.0 V or more based on a Fc/Fc⁺ electrode standard, and an ionic conductivity at 25° C. be 0.1 S/cm or more.

A composite electrolyte of the present invention contains: a lithium salt; and the above-mentioned dicationic ionic liquid.

It is preferable that the above-mentioned composite electrolyte further contain a viscosity reducing agent.

A composite electrolyte of the present invention contains: anionic liquid; and a lithium salt, in which a ratio expressed by the following expression is 20% or more. It is preferable that the ionic liquid be a dicationic ionic liquid.

Iₗᵢₘ/Iᵢₙᵢ Expression:

(In the expression, Iₗᵢₘ is a limiting current density, and is a current density when the current density is approximately constant for 1 hour or longer in a case where a current density value is measured while applying a constant voltage of 0.1 V to the composite electrolyte at 25° C.; and Iᵢₙᵢ is a current density at 1 second after start of application of a constant voltage of 0.1 V to the composite electrolyte.)

It is preferable that a value of the limiting current density of the above-mentioned composite electrolyte be 90 μA/cm² or more.

### Advantageous Effects of Invention

According to the present invention, it is possible to provide an ionic liquid and a dicationic ionic liquid which can improve lithium ion transport numbers when used as a composite electrolyte. Furthermore, according to the present invention, it is possible to provide a composite electrolyte in which a lithium ion transport number is improved.

### BRIEF DESCRIPTION OF DRAWINGS

FIG. 1 is a diagram showing the results of a lithium dissolution and deposition cycle test of Example B6.

FIG. 2 is a diagram showing the results of a lithium dissolution and deposition cycle test of Comparative Example B1.

FIG. 3 is a diagram showing the results of a lithium dissolution and deposition cycle test of Example B7.

FIG. 4 is a diagram showing the results of a lithium dissolution and deposition cycle test of Example B8.

FIG. 5 is a diagram showing the results of a lithium dissolution and deposition cycle test of Example B9.

FIG. 6 is a diagram showing the results of a lithium dissolution and deposition cycle test of Example B10.

FIG. 7 is a diagram showing the results of a lithium dissolution and deposition cycle test of Comparative Example B2.

FIG. 8 is a diagram showing the results of a lithium dissolution and deposition cycle test of Example B11.

FIG. 9 is a diagram showing the results of a lithium dissolution and deposition cycle test of Example B12.

FIG. 10 is a diagram showing the results of a lithium dissolution and deposition cycle test of Example B13.

FIG. 11 is a diagram showing the results of a lithium dissolution and deposition cycle test of Example B14.

### DESCRIPTION OF EMBODIMENTS

### First Embodiment

The invention according to the first embodiment relates to a dicationic ionic liquid. The dicationic ionic liquid contains a cation that has two moieties each containing a heteroatom having a positive formal charge, and a linking group bonding to each of the heteroatoms of the two moieties to link the two moieties, in which the linking group is represented by a formula: —CR¹R²OCR³R⁴CR⁵R⁶OCR⁷R⁸—. The ionic liquid is a compound that is a liquid at 25° C., for example.

In other words, the dicationic ionic liquid of the present embodiment has two moieties within the cation, and the two moieties are linked by the above-mentioned linking group. Since both of the two moieties contain a heteroatom having a positive formal charge, each thereof is a moiety having a positive charge (hereinafter also referred to as a cationic moiety). The linking group bonds directly to the heteroatom having a positive charge in the cationic moiety. The two moieties can be written as A and B, respectively, the above-mentioned linking group can be written as Y, and the above-mentioned cation can be written as A-Y—B. A and B may have the same chemical structure or may have different chemical structures. In other words, the dicationic ionic liquid of the present embodiment may be a symmetrical dicationic ionic liquid (where two cationic moieties have the same chemical structure), or may be an asymmetrical dicationic ionic liquid (where two cationic moieties have different chemical structures). Asymmetrical dicationic liquids tend to have high heat stability and an excellent 10% weight loss temperature.

In the linking group, R¹ to R⁸ are each a hydrogen atom, a fluorine atom, or a monovalent organic group having 1 to 20 carbon atoms; the organic group is represented by a formula: —R^{A}—(X—R^{B})ₙ—R^{C}; R^{A} is a covalent bond or a substituted or unsubstituted divalent hydrocarbon group; X is —O—, —S—, —C(═O)—, —C(═O)O—, or —OC(═O)—; R^{B} is a covalent bond or a substituted or unsubstituted divalent hydrocarbon group; and R^{C} is a substituted or unsubstituted monovalent hydrocarbon group. n is 0 or more, may be 1 to 8, may be 1 to 5, or may be 1 to 3.

The above-mentioned organic group may be a hydrocarbon group or a substituted hydrocarbon group (that is, R^{A} is a covalent bond, and n is 0). The hydrocarbon group is not particularly limited, and may be any of an aliphatic hydrocarbon group or an aromatic hydrocarbon group. In the present specification, the term “aromatic hydrocarbon group” means a hydrocarbon group containing an aromatic moiety, and also includes a hydrocarbon group having an aliphatic moiety. The aromatic hydrocarbon group is a hydrocarbon group containing an aromatic moiety, and examples thereof include a phenyl group and a benzyl group. Examples of aliphatic hydrocarbon groups include hydrocarbon groups containing alicyclic moieties such as a cyclohexyl group and a cyclohexylethyl group; linear aliphatic hydrocarbon groups such as a methyl group, an ethyl group, and an allyl group; and branched aliphatic hydrocarbon groups such as an isopropyl group. In the substituted hydrocarbon group, the above-mentioned hydrocarbon group may be substituted with a monovalent group such as a halogen atom, an alkoxy group, and a polyalkylene oxide group. Examples of substituted hydrocarbon groups include a partially fluorinated or fully fluorinated hydrocarbon group, and a group having an alkoxy group such as a methoxyethyl group and an ethoxyethyl group.

The above-mentioned organic group may have 1 to 15 carbon atoms, may have 1 to 10 carbon atoms, may have 1 to 5 carbon atoms, or may have 1 to 3 carbon atoms. The organic group is preferably an alkyl group, or is preferably a group in which one or more of the above-mentioned X's are contained in the chain of an alkyl group and in which X forms a carbon atom-X-carbon atom bond.

In the linking group, 4 or more of R¹ to R⁸ are hydrogen atoms. It is preferable that 6 or more thereof be hydrogen atoms, and all be hydrogen atoms (that is, the linking group is a —CH₂—O—CH₂—CH₂—O—CH₂— group)).

A composite electrolyte containing the dicationic ionic liquid of the present embodiment and a lithium salt exhibits a high lithium ion transport number when a voltage is applied to the composite electrolyte to cause a current to flow. Although the reason why the dicationic ionic liquid of the present embodiment is able to provide the composite electrolyte exhibiting such a high lithium ion transport number is not completely elucidated, the inventors of the present invention consider the reason to be as follows. Composite electrolytes in which a lithium salt is dissolved in a conventional ionic liquid (hereinafter also referred to as a monocationic ionic liquid) which has only one cationic moiety in a chemical structure of a cation such as imidazolium salts and pyrrolidinium salts have been widely used. However, when used as an electrolyte in a battery, because a monocationic ionic liquid such as imidazolium ions has a high cation mobility, the monocationic ionic liquid makes a large contribution to the overall current. In other words, the contribution of lithium ions in a composite electrolyte containing a monocationic ionic liquid and a lithium salt to the current (that is, the transport number) is relatively small. Furthermore, because the oxygen atom in the above-mentioned linking group and the heteroatoms of the cationic moieties are linked via a very short carbon chain (one carbon), the cation has excellent electrochemical stability (high-voltage withstanding characteristics).

The cationic moiety in the dicationic ionic liquid is an organic cationic moiety and is a moiety having one or more heteroatoms having a positive formal charge. The term “heteroatom” means an atom other than a carbon atom and a hydrogen atom. The heteroatom having a positive formal charge may be at least one selected from nitrogen group atoms and chalcogen, and is preferably a nitrogen atom, a phosphorus atom, or a sulfur atom.

The above-mentioned cationic moiety may have a heterocyclic ring, and may have the above-mentioned heteroatom having a positive formal charge as a ring member in the heterocyclic ring. Furthermore, the cationic moiety may not contain the above-mentioned heteroatom having a positive formal charge as a ring member in the ring structure.

The charge of the cationic moiety may be a valence of +1 or higher, a valence of +1 to +3, or a valence of +1. The charges of the two cationic moieties in the cation may be the same as or different from each other, and both cationic moieties preferably have a valence of +1. When the cationic moiety has a plurality of heteroatoms, and the charges are dispersed among the plurality of heteroatoms due to the resonance effect, the charges of the cationic moiety may be the sum of the charges of the plurality of heteroatoms.

Specific examples of the cationic moieties include cationic groups such as a quaternary ammonium group, a quaternary phosphonium group, a sulfonium group, an oxazolium group, and a thiazolium group.

Examples of quaternary ammonium groups and quaternary phosphonium groups include cationic groups represented by the following chemical formulas.

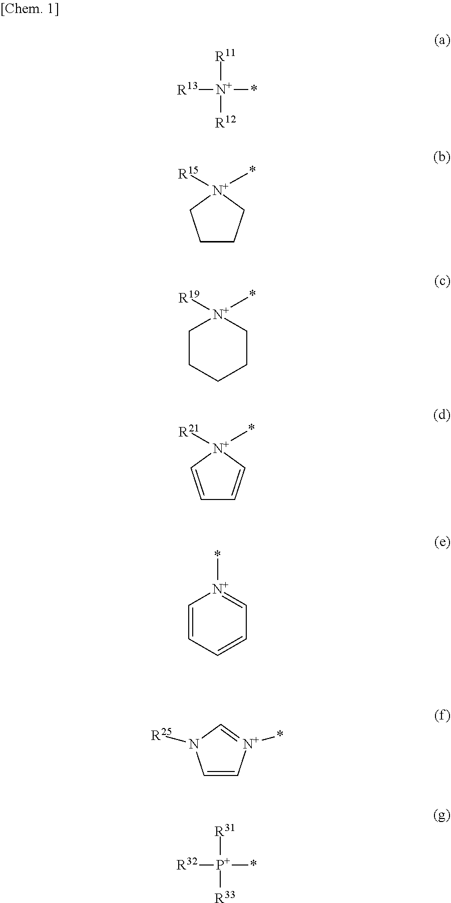

R¹¹ to R¹³, R¹⁵, R¹⁹, R²¹, R²⁵, and R³¹ to R³³ may be monovalent hydrocarbon groups having 1 to 20 carbon atoms, or may be monovalent substituted hydrocarbon groups. The hydrocarbon group may be any of an aliphatic hydrocarbon group or an aromatic hydrocarbon group. The number of carbon atoms in the hydrocarbon group is preferably 1 to 10, and more preferably 1 to 5. The aromatic hydrocarbon group is a hydrocarbon group containing an aromatic moiety, and examples thereof include a phenyl group and a benzyl group. Examples of aliphatic hydrocarbon groups include hydrocarbon groups containing alicyclic moieties such as a cyclohexyl group and a cyclohexylmethyl group; linear aliphatic hydrocarbon groups such as a methyl group, an ethyl group, an n-propyl group, an n-butyl group, an n-octyl group, an n-decyl group, an allyl group, and an oleyl group; and branched aliphatic hydrocarbon groups such as an isopropyl group. The substituted hydrocarbon group may be a substituted hydrocarbon group in which a hydrocarbon group having 1 to 20 carbon atoms is further substituted with a monovalent group such as a halogen atom, an alkoxy group, and a polyalkylene oxide group. Examples of substituted alkyl groups include a partially fluorinated or fully fluorinated alkyl group, a methoxyethyl group, and an ethoxyethyl group.

R¹¹ to R¹³ are preferably a hydrocarbon group having 1 to 10 carbon atoms, more preferably a hydrocarbon group having 1 to 5 carbon atoms, and further preferably a hydrocarbon group having 1 to 3 carbon atoms. The hydrocarbon group is preferably an alkyl group. R¹¹ to R¹³ may be the same as or different from each other. For example, it is preferable that R¹¹ and R¹² be the same alkyl group having 1 to 5 carbon atoms, and R¹³ be an alkyl group that has 1 to 5 carbon atoms and is different from R¹¹ and R¹²; it is more preferable that R¹¹ and R¹² be the same alkyl group having 1 to 3 carbon atoms, and R¹³ be an alkyl group that has 1 to 3 carbon atoms and is different from R¹¹ and R¹²; and it is further preferable that R¹¹ and R¹² be an ethyl group, and R¹³ be a methyl group.

R¹⁵ is preferably a hydrocarbon group having 1 to 10 carbon atoms, more preferably a hydrocarbon group having 1 to 5 carbon atoms, and further preferably a hydrocarbon group having 1 to 3 carbon atoms. The hydrocarbon group is preferably an alkyl group, more preferably a methyl group or an ethyl group, and further preferably a methyl group.

R¹⁹ is preferably a hydrocarbon group having 1 to 10 carbon atoms, more preferably a hydrocarbon group having 1 to 5 carbon atoms, and further preferably a hydrocarbon group having 1 to 3 carbon atoms. The hydrocarbon group is preferably an alkyl group, more preferably a methyl group or an ethyl group, and further preferably a methyl group.

R²¹ is preferably a hydrocarbon group having 1 to 10 carbon atoms, more preferably a hydrocarbon group having 1 to 5 carbon atoms, and further preferably a hydrocarbon group having 1 to 3 carbon atoms. The hydrocarbon group is preferably an alkyl group, more preferably a methyl group or an ethyl group, and further preferably a methyl group.

R²⁵ is preferably a hydrocarbon group having 1 to 10 carbon atoms, more preferably a hydrocarbon group having 1 to 5 carbon atoms, and further preferably a hydrocarbon group having 1 to 3 carbon atoms. The hydrocarbon group is preferably an alkyl group, more preferably a methyl group or an ethyl group, and further preferably a methyl group.

R³¹ to R³³ are preferably a hydrocarbon group having 1 to 10 carbon atoms, more preferably a hydrocarbon group having 1 to 8 carbon atoms, further preferably a hydrocarbon group having 1 to 5 carbon atoms, and even further preferably a hydrocarbon group having 1 to 3 carbon atoms. The hydrocarbon group is preferably an alkyl group. R³¹ to R³³ may be the same as or different from each other. For example, R³¹ to R³³ are preferably an alkyl group having 1 to 5 carbon atoms, preferably an alkyl group having 1 to 4 carbon atoms, further preferably a methyl group, an ethyl group, or a butyl group, and particularly preferably a butyl group.

A polyalkylene oxide group is a group represented by a formula: —(OR)ᵣOR′, and in the formula, r is preferably 1 to 10, more preferably 1 to 5, and further preferably 1 to 2. When there is a plurality of R′s, they may be different from each other. R is an alkylene group having 1 to 3 carbon atoms, is preferably an ethylene group or a 1,2-propylene group, and is more preferably an ethylene group. R′ is an alkyl group having 1 to 3 carbon atoms, and is preferably a methyl group or an ethyl group.

In the chemical formulas (a) to (g), each of *'s indicates the position to which the above-mentioned linking group bonds. A hydrogen atom bonding to a carbon atom contained in the ring structures represented by the chemical formulas (b) to (f) may be substituted with a substituent. Examples of substituents include monovalent groups such as a halogen atom, a hydrocarbon group having 1 to 10 carbon atoms, a group having a heterocyclic ring, an alkoxy group, and a polyalkylene oxide group. The hydrocarbon group as a substituent may be any of an aliphatic hydrocarbon group and an aromatic hydrocarbon group. The aromatic hydrocarbon group is a hydrocarbon group containing an aromatic moiety, and examples thereof include a phenyl group and a benzyl group. Examples of aliphatic hydrocarbon groups include hydrocarbon groups containing alicyclic moieties such as a cyclohexyl group and a cyclohexylethyl group; linear aliphatic hydrocarbon groups such as a methyl group, an ethyl group, and an allyl group; and branched aliphatic hydrocarbon groups such as an isopropyl group. The hydrocarbon group as a substituent may be further substituted with a monovalent group such as a halogen atom, a hydrocarbon group having 1 to 10 carbon atoms, an alkoxy group, and a polyalkylene oxide group.

The cationic groups of the chemical formulas (b) to (f) may have another ring structure (fused ring) which is fused to the ring structures represented by the chemical formulas (b) to (f) by substitution of two or more hydrogen atoms bonding to carbon atoms contained in each of the ring structures. The fused ring may be any of an aliphatic ring and an aromatic ring, and may be any of a hydrocarbon ring having only carbon atoms as ring members and a heterocyclic ring having heteroatoms as ring members. Examples of cationic groups having a fused ring include a benzimidazolium group and an acridinium group. The hydrogen atom of the fused ring may also be substituted with a monovalent group such as a halogen atom, a hydrocarbon group having 1 to 10 carbon atoms, a group having a heterocyclic ring, an alkoxy group, and a polyalkylene oxide group.

The cation contained in the dicationic ionic liquid is preferably those represented by the following chemical formulas (I) to (V).

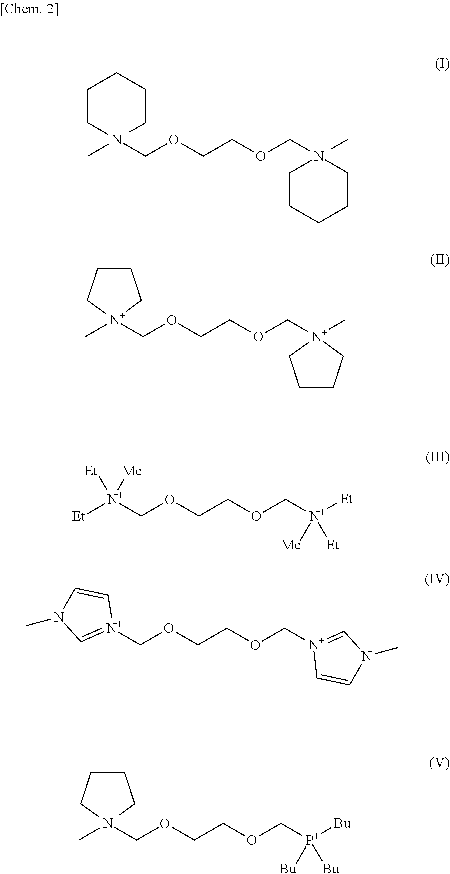

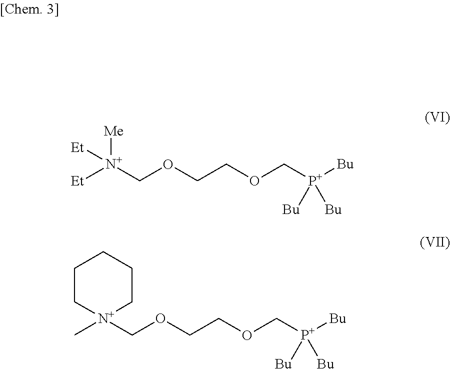

The anion of the dicationic ionic liquid is not particularly limited, and may be appropriately selected depending on charges of the cation of the dicationic ionic liquid. Examples of anions include monovalent anions such as Cl⁻, Br⁻, I⁻, ClO₄⁻, PF₆⁻, BF₄⁻, CF₃SO₃⁻, (FSO₂)₂N⁻, (CF₃SO₂)₂N⁻, (CₘF₂ₘ₊₁SO₂)₂N⁻ (where m is an integer of 2 or more), and HSO₃⁻; and divalent or higher anions such as SO₃²⁻. From the viewpoint of electrochemical stability, PF₆⁻, BF₄⁻, CF₃SO₃⁻, (FSO₂)₂N⁻, (CF₃SO₂)₂N⁻, or (CₘF₂ₘ₊₁SO₂)₂N⁻ is preferable, and (CF₃SO₂)₂N⁻ is more preferable. The above-mentioned dicationic ionic liquid may contain only one type of anion, or may contain two or more types of anions.

The upper limit of the potential window of the dicationic ionic liquid of the present embodiment is preferably 2.0 V or more and is more preferably 2.05 or more based on a Fc/Fc⁺ (ferrocene/ferrocenium) electrode standard. The potential window can be measured by cyclic voltammetry, for example. The potential window is a potential range in which an oxidation-reduction reaction does not substantially occur, and can be a range in which a current of 50 μA/cm² or more does not flow in a cyclic voltammetry test, for example. In other words, in the cyclic voltammetry test, a potential at which a current of 50 μA/cm² or more flows for the first time when sweeping the potential to the oxidation side is the upper limit of the potential window, and a potential at which a current of 50 μA/cm² or more flows for the first time when sweeping the potential to the reduction side is the lower limit of the potential window. The lower limit of the potential window may be −2.40 V or less based on the Fc/Fc⁺ electrode standard, for example. Furthermore, the lower limit of the potential window of the dicationic ionic liquid is −2.40 or less based on the Fc/Fc⁺ electrode standard, and the upper limit of the potential window is 2.0 V or more based on the Fc/Fc⁺ electrode standard.

Furthermore, it is preferable that the ionic conductivity of the dicationic ionic liquid of the present embodiment at 25° C. be 0.1 S/cm or more.

The 10% weight loss temperature of the dicationic ionic liquid of the present embodiment is preferably 280° C. or higher, more preferably 290° C. or higher, and further preferably 300° C. or higher when measured at a temperature rising rate of 5° C./minute (measurement condition 1). The 10% weight loss temperature can be measured with a thermogravimetric analyzer. In the case of the measurement condition 1, a measurement starting temperature may be 40° C., and a final temperature can be set to 500° C., although there is no particular limitation. In the case of the measurement condition 1, the 10% weight loss temperature of the dicationic ionic liquid of the present embodiment may be 370° C. or lower, may be 280° C. to 370° C., may be 290° C. to 360° C., and may be 300° C. to 350° C.

In addition, the 10% weight loss temperature of the dicationic ionic liquid of the present embodiment may be measured by heating to 150° C. under the condition of a temperature rising rate of 10° C./minute, and thereafter heating from 150° C. to 350° C. at a temperature rising rate of 1° C./minute (measurement condition 2). In the case of the measurement condition 2, the 10% weight loss temperature is preferably 190° C. or higher, more preferably 200° C. or higher, and further preferably 300° C. or higher. A measurement starting temperature may be room temperature (25° C.), and a final temperature can be set to 500° C., although there is no particular limitation. In the case of the measurement condition 2, the 10% weight loss temperature of the dicationic ionic liquid of the present embodiment may be 310° C. or lower, may be 190° C. to 310° C., may be 200° C. to 300° C., and may be 210° C. to 290° C. In the measurement condition 2, 150° C. may be maintained for 10 minutes or longer, or for 10 minutes to stabilize temperature control. A maintaining time for such temperature control can be set as appropriate depending on devices used. Furthermore, the temperature rising rate may be set at 10° C./minute from 350° C. to 500° C.

A method for obtaining the dicationic ionic liquid of the present embodiment is not particularly limited, and there is no problem as long as a structure in which two cationic moieties are linked by the above-mentioned linking group can be obtained. Examples thereof include a method including the following steps.

[Step 1] An ammonium halide salt is obtained by mixing 1,2-bischloromethoxyethane or a derivative thereof and an amine at a molar ratio of 1:2 to 1:2.5 under a protective gas atmosphere, thereafter heating to 25° C. to 60° C., and stirring to react, for example. 1,2-Bischloromethoxyethane or a derivative thereof is selected to correspond to the chemical structure of the linking part of the dicationic ionic liquid to be obtained, and has the same groups as those of R¹ to R⁸ of the linking part (for example, when R¹ to R⁸ are all hydrogen atoms, 1,2-bischloromethoxyethane corresponds to the above-mentioned linking group). Furthermore, the amine is selected to correspond to the chemical structure of the cationic moiety of the dicationic ionic liquid to be obtained.

[Step 2]A dicationic ionic liquid is obtained by mixing the ammonium halide salt prepared in Step 1 and a salt having a formula of MₐY_{b} at a molar ratio of 1:2 to 1:2.5, and thereafter stirring to cause an ion exchange reaction. M is a counter cation of the anion Y, and a and b are the ratio of the numbers of ions of both the cation M and the anion Y when the charges thereof are balanced. Examples of the cation M include alkali metal ions.

The composite electrolyte of the present embodiment includes the above-mentioned dicationic ionic liquid and a lithium salt. Such a composite electrolyte can be used as an electrolyte (non-aqueous electrolyte) for electrochemical devices such as lithium ion batteries and capacitors.

Examples of lithium salts include, but are not limited to, LiCl, LiBr, LiI, LiClO₄, LiPF₆, LiBF₄, LiCF₃SO₃, Li[(FSO₂)₂N], Li[(CF₃SO₂)₂N], Li[(CₘF₂ₘ₊₁SO₂)₂N](where m is an integer of 2 or more), LiHSO₃, and Li₂SO₃. The anion contained in the lithium salt may be the same as or different from the anion contained in the dicationic ionic liquid.

The composite electrolyte may further contain a viscosity reducing agent. By lowering the viscosity of the composite electrolyte, the ionic conductivity in the electrolyte can be further improved. Examples of the viscosity reducing agent include organic solvents. The organic solvent is not particularly limited and may be an aprotic solvent. Examples thereof include chain carbonates such as dimethyl carbonate, diethyl carbonate, and ethylmethyl carbonate; cyclic carbonates such as ethylene carbonate, propylene carbonate, butylene carbonate, and vinylene carbonate; aliphatic carboxylic acid esters such as methyl acetate, ethyl acetate, methyl propionate, ethyl propionate, methyl butyrate, methyl isobutyrate, and methyl trimethyl acetate; cyclic ethers such as tetrahydrofuran, 2-methyltetrahydrofuran, tetrahydropyran, and 1,3-dioxolane; chain ethers such as 1,2-diethoxyethane and ethoxymethoxyethane; lactones such as γ-butyrolactone; lactams such as ε-caprolactam and N-methylpyrrolidone; sulfones such as sulfolane; and halogen-substituted products of these solvents. Only one type of the solvent may be used, or a mixed solvent of two or more types of solvents may be used. Among these, cyclic carbonates are preferable, and mixed solvents of ethylene carbonate and propylene carbonate are preferable.

The content of the viscosity reducing agent in the composite electrolyte is not particularly limited, and is preferably 10% by mass or more, more preferably 15% by mass, and particularly preferably 20% by mass or more with respect to the dicationic ionic liquid. Furthermore, 100% by mass or less is preferable, 85% by mass or less is more preferable, and 70% by mass or less is particularly preferable.

The concentration of the lithium salt in the composite electrolyte is not particularly limited, but in terms of lithium ions (that is, lithium ion concentration), the concentration is preferably 0.1 mol/kg or more (in this case, the upper limit may be the saturated concentration of the lithium salt), and is more preferably 0.1 to 2.0 mol/lkg. The unit mol/kg is a mass mol concentration, and is the molar amount of the lithium salt (in terms of lithium ion) per unit mass (kg) of the solvent.

### Second Embodiment

The invention according to the second embodiment relates to an ionic liquid. The ionic liquid according to the second embodiment is an ionic liquid in which, when a composite electrolyte which contains the ionic liquid and a lithium salt and in which a concentration of the lithium salt is 0.5 mol/kg in terms of lithium ions is prepared, a ratio expressed by the following expression (I) for the composite electrolyte at 25° C. is 10% or more.

Iₗᵢₘ/Iᵢₙᵢ Expression:

(In the expression, Iₗᵢₘ is the limiting current density of the composite electrolyte, and Iᵢₙᵢ is a current density 1 second after the start of voltage application in the stage in which the limiting current density is first reached in a method of measuring a limiting current density while increasing a voltage applied to the composite electrolyte stepwise.) The composite electrolyte for Iₗᵢₘ/Iᵢₙᵢ measurement in regard to the ionic liquid preferably contains 90% by mass or more of the ionic liquid and a lithium salt with respect to the total amount of the composite electrolyte, more preferably contain 95% by mass or more thereof, further preferably contains 98% by mass or more thereof, and particularly preferably contains 99% by mass or more thereof, and it is preferable that substantially no components other than the ionic liquid and the lithium salt be contained.

When a voltage is applied to the composite electrolyte, at the initial stage of voltage application, all ions contained in the electrolyte move and contribute to the current. At the time of the steady state for 30 minutes after voltage application, only lithium ions contribute to the current. Therefore, Iₗᵢₘ/Iᵢₙᵢ is an index of the contribution ratio of lithium ions to the total current density. It can be said that the higher the contribution ratio of lithium ions to the total current density, the higher the transport number of lithium ions.

Iₗᵢₘ/Iᵢₙᵢ in regard to the ionic liquid is preferably 12% or more, more preferably 15% or more, further preferably 20% or more, even further preferably 25% or more, and particularly preferably 30% or more.

The ionic liquid according to the second embodiment is preferably a dicationic ionic liquid. Dicationic ionic liquids are ionic liquids that contain cations having two cationic moieties within their structure. Dicationic ionic liquids have a larger cation size than that of monocationic ionic liquids and also have great interaction with anions, and thus are tend to have lower mobility when a voltage is applied. Therefore, there is a tendency that Iₗᵢₘ/Iᵢₙᵢ can be further improved. The anion contained in the ionic liquid according to the second embodiment is not particularly limited, and examples thereof include the same anions as those of the dicationic ionic liquid according to the first embodiment.

The dicationic ionic liquid preferably has a structure in which two cationic moieties are linked by a linking group. The linking group is preferably a group in which the number of atoms counted along the chain connecting the atom directly bonding to one cationic moiety in the linking group and the atom directly bonding to the other cationic moiety is 6. It is preferable that two of the six atoms be oxygen atoms or sulfur atoms, and the remaining be carbon atoms.

As the ionic liquid according to the second embodiment, the dicationic ionic liquid according to the first embodiment is preferable.

The composite electrolyte of the present embodiment contains the above-mentioned ionic liquid and a lithium salt. When Iₗᵢₘ/Iᵢₙᵢ is measured at 25° C. for the composite electrolyte, Iₗᵢₘ/Iᵢₙᵢ may be 10% or more, preferably 12% or more, more preferably 15% or more, further preferably 20% or more, even further preferably 25% or more, and particularly preferably 30% or more. Iᵢₙᵢ is a current density 1 second after the start of voltage application in the stage in which the limiting current density is first reached in a method of measuring a limiting current density while increasing a voltage applied to the composite electrolyte stepwise. The concentration of the lithium salt in the composite electrolyte is not particularly limited, but in terms of lithium ions (that is, lithium ion concentration), the concentration is preferably 0.1 mol/kg or more (in this case, the upper limit may be the saturated concentration of the lithium salt), and is more preferably 0.1 to 2.0 mol/lkg.

The composite electrolyte of the present embodiment may further contain a viscosity reducing agent.

Specific examples of lithium salts and viscosity reducing agents in the composite electrolyte are the same as the specific examples of lithium salts and viscosity reducing agents which may be contained in the composite electrolyte containing the ionic liquid of the first embodiment. The same applies to specific examples of the content of the viscosity reducing agent.

The limiting current density and the initial current density of the composite electrolyte can be measured by the following measurement method I, for example. In the measurement method I, first, a step of applying a constant voltage to the composite electrolyte for a predetermined time t is repeatedly performed while increasing the applied voltage stepwise. In each step, a current density Iₜ at a time t when a voltage application start point is set to the origin point is measured. When the measured current density becomes approximately constant regardless of the applied voltage, this current density is used as the limiting current.

Specifically, for example, as a first step, a constant voltage of 0.4 V is applied for 30 minutes (t=30 minutes), and a current density 130 (current density at the time of 30 minutes when voltage application start is set to 0 minutes) after 30 minutes is measured. Next, after allowing the composite electrolyte to stand for a predetermined time interval (for example, 10 to 15 minutes) without applying any voltage, a constant voltage (that is, 0.6 V) which is 0.2 V higher than the voltage value in the above-mentioned first step is applied to the composite electrolyte for 30 minutes to measure the current density after 30 minutes in the same manner as in the first step. Thereafter, the step of applying a constant voltage for 30 minutes is repeated while increasing the applied voltage by 0.2 V as compared the previous step, and I₃₀ at each step is measured in the same manner. Then, whether the current density does not change even when the voltage is increased is confirmed, and the constant current density is set as the limiting current density.

When the voltage value of the step in which I₃₀ first reaches the limiting current density among the I₃₀'s measured in each of the above-mentioned steps is applied to the composite electrolyte, a current density measured 1 second after the start of voltage application is denoted by Iᵢₙᵢ. The Iᵢₙᵢ is used as the initial current density.

The voltage value of the first step, the increase width of the voltage value for each step, and the time interval between the steps can be changed as appropriate according to the properties and the like of samples.

The limiting current density of the composite electrolyte can also be measured by the following measurement method II. In the measurement method II, first, a constant voltage (for example, 0.1 V) is continuously applied to the composite electrolyte, and a current density value when the current density does not change over time for one hour or longer is used as the limiting current. In this case, the initial current value is a current density value 1 second after the start of applying the above-mentioned constant voltage to the composite electrolyte.

When the limiting current density and initial current value are measured by the measurement method II, Iₗᵢₘ/Iᵢₙᵢ is preferably 20% or more, more preferably 22% or more, and further preferably 25% or more.

The measurement method II is a particularly effective method when measuring the limiting current density and initial current value of the composite electrolyte containing a viscosity reducing agent (for example, a solvent). The limiting current density of the composite electrolyte measured by the measurement method II is preferably 90 μA/cm² or more, more preferably 150 μA/cm² or more, further preferably 200 μA/cm² or more, and particularly preferably 300 μA/cm² or more.

The ionic liquids of the first and second embodiments have a high lithium ion transport number when used as a composite electrolyte, and thus are useful as electrolytes for electrochemical devices such as lithium ion batteries and capacitors. In addition, the composite electrolyte containing the ionic liquid of the first and second embodiments tends to be able to effectively prevent the generation of dendrites.

### EXAMPLES

### <Sample>

Compounds A to E and Compounds CA and CB were prepared as described below.

### <Compound A>

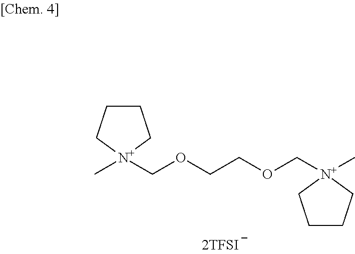

Compound A ([(Pyr₁)₂MEM][2TFSI]) represented by the above formula was synthesized as follows.

After dissolving 1,2-bischloromethoxyethane (3.30 g, 20.8 mmol) in CH₂Cl₂ (30 mL), N-methylpyrrolidine (3.63 g, 42.6 mmol) was added thereto to stir at room temperature overnight under an Ar atmosphere. After distilling off the solvent, washing with diethyl ether and vacuum drying were performed to obtain [(Pyr₁)₂MEM][2Cl] (6.69 g, 20.3 mmol, yield: 98%) as a white solid. The NMR data of the product is shown below.

¹H-NMR (CDCl₃, 600 MHz) δ (ppm): 2.22-2.35 (m, 8H), 3.36 (s, 6H), 3.67 (m, 4H), 3.95 (m, 4H), 4.23 (s, 4H), 5.47 (s, 4H)

¹³C-NMR (CD₃OD, 150 Hz) δ (ppm): 23.5, 48.4, 62.5, 73.6, 91.4

The obtained [(Pyr₁)₂MEM][2Cl] (2.51 g, 7.62 mmol) and LiTFSI (4.17 g, 14.5 mmol) were dissolved in CH₃OH (15 mL) to stir at room temperature overnight. CH₃OH was distilled off. Thereafter, the product was dissolved in dichloromethane, washing with water was performed thereafter, and an organic phase was separated by liquid separation. The organic phase was vacuum dried to obtain a colorless and transparent liquid (4.35 g, 5.31 mmol, 70%). The NMR data of the product is shown below. Unless otherwise specified, chemical shifts for ¹H-NMR and ¹³C-NMR are based on H or C of chloroform when a deuterated solvent used for measurement is deuterated chloroform (CDCl₃), and are based on H or C of a methyl group of methanol when a deuterated solvent is deuterated methanol (CD₃OD).

¹H-NMR (CD₃OD, 600 MHz) δ (ppm): 2.38 (d, J=9.0 Hz, 8H), 3.61 (m, 4H), 3.76 (t, J=5.6 Hz, 4H), 4.23 (s, 4H), 4.88 (s, 4H)

¹³C-NMR (CD₃OD, 150 Hz) δ (ppm): 23.3, 62.4, 73.4, 91.5, 121 (q, J=319 Hz)

### <Compound B>

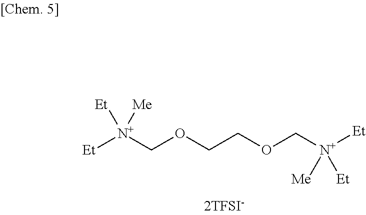 [SMILES: CC[N+](C)(CC)COCCOC[N+](C)(CC)CC]

Compound B ([(N₂₂₁)₂MEM][2TFSI]) represented by the above formula was synthesized as follows.

After dissolving 1,2-bischloromethoxyethane (3.29 g, 20.7 mmol) in CH₂Cl₂ (30 mL), N,N-diethylmethylamine (3.73 g, 42.8 mmol) was added thereto to stir at room temperature overnight under an Ar atmosphere. After distilling off the solvent, washing with diethyl ether and vacuum drying were performed to obtain [(N₂₂₁)₂MEM] [2Cl](quant) as a white solid. The NMR data of the product is shown below. When the yield of a product is substantially 100%, this is written as quant.

¹H-NMR (CDCl₃, 600 MHz) δ (ppm): 1.42 (t, J=17.5 Hz, 12H), 3.26 (s, 6H), 3.59 (m, 8H), 4.24 (s, 4H), 5.40 (s, 4H)

¹³C-NMR (CD₃OD, 150 Hz) δ (ppm): 8.19, 45.1, 55.2, 73.3, 89.0

The obtained [(N₂₂₁)₂MEM] [2Cl] (5.44 g, 16.3 mmol) and LiTFSI (9.82 g, 34.2 mmol) were dissolved in CH₃OH (35 mL) to stir at room temperature overnight. CH₃OH was distilled off. Thereafter, the product was dissolved in dichloromethane, washing with water was performed thereafter, and an organic phase was separated by liquid separation. The organic phase was vacuum dried to obtain a colorless and transparent liquid (7.31 g, 8.89 mmol, 55%). The NMR data of the product is shown below.

¹H-NMR (CD₃OD, 600 MHz) δ (ppm): 1.37 (t, J=7.3 Hz, 12H), 3.01 (s, 6H), 3.42 (m, 8H), 4.08 (s, 4H), 4.74 (s, 4H)

¹³C-NMR (CD₃OD, 150 Hz) δ (ppm): 8.06, 45.1, 55.4, 73.2, 87.0, 121 (q, J=319 Hz)

### <Compound C>

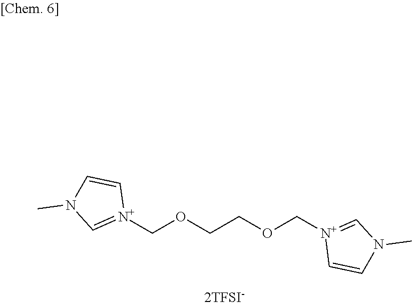

Compound C ([(Mim)₂MEM] [2TFSI]) represented by the above formula was synthesized as follows.

After dissolving 1,2-bischloromethoxyethane (3.44 g, 21.6 mmol) in CH₂Cl₂ (30 mL), N-methylimidazole (3.96 g, 48.2 mmol) was added thereto to stir at room temperature overnight under an Ar atmosphere. After distilling off the solvent, washing with diethyl ether and vacuum drying were performed to obtain [(Mim)₂MEM] [2Cl] (6.85 g, 21.2 mmol, 98%) as a white solid.

¹H-NMR (CD₃OD, 600 MHz) δ (ppm): 3.81 (s, 4H), 4.03 (s, 6H), 5.69 (s, 4H), 7.70 (s, 2H), 7.81 (s, 2H), 9.23 (s, 2H)

The obtained [(Mim)₂MEM] [2Cl] (3.18 g, 9.84 mmol) and LiTFSI (5.86 g, 20.4 mmol) were dissolved in CH₃OH (20 mL) to stir at room temperature overnight. CH₃OH was distilled off. Thereafter, the product was dissolved in dichloromethane, washing with water was performed thereafter, and an organic phase was separated by liquid separation. The organic phase was vacuum dried to obtain a colorless and transparent liquid (4.10 g, 5.05 mmol, 51%).

¹H-NMR (CDCl₃, 600 MHz) δ (ppm): 3.66 (s, 4H), 4.12 (q, J=7.2 Hz, 6H), 5.47 (s, 4H), 7.34 (s, 2H), 7.44 (s, 2H), 8.61 (s, 2H)

¹³C-NMR (CD₃OD, 150 Hz) δ (ppm): 37.5, 71.3, 81.2, 124, 123 (q, J=319 Hz), 139

### <Compound D>

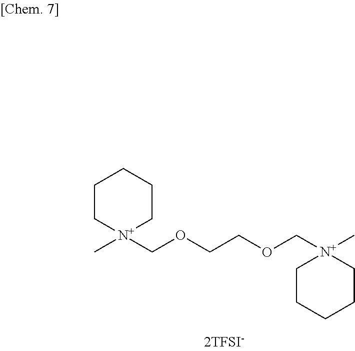 [SMILES: C[N+]1(COCCOC[N+]2(C)CCCCC2)CCCCC1]

Compound D ([(Pip₁)₂MEM] [2TFSI]) represented by the above formula was synthesized as follows.

After dissolving 1,2-bischloromethoxyethane (3.36 g, 21.2 mmol) in CH₂Cl₂ (30 mL), N-methylpiperidine (4.36 g, 44.0 mmol) was added thereto to stir at room temperature overnight under an Ar atmosphere. After distilling off the solvent, washing with diethyl ether and vacuum drying were performed to obtain [(Pip)₂MEM] [2Cl] (4.19 g, 11.9 mmol, 59%) as a white solid.

¹H-NMR (CDCl₃, 600 MHz) δ (ppm): 1.70-1.74 (m, 4H), 1.86-1.97 (m, 16H), 3.33 (s, 6H), 4.24 (s, 4H), 5.53 (s, 4H)

¹³C-NMR (CD₃OD, 150 Hz) δ (ppm): 20.9, 22.6, 45.7, 58.9, 74.2, 92.7

The obtained [(Pip₁)₂MEM] [2Cl] (2.51 g, 7.02 mmol) and LiTFSI (4.17 g, 14.5 mmol) were dissolved in CH₃OH (15 mL) to stir at room temperature overnight. CH₃OH was distilled off. Thereafter, the product was dissolved in dichloromethane, washing with water was performed thereafter, and an organic phase was separated by liquid separation. Vacuum drying was performed to obtain a yellow liquid (4.35 g, 5.14 mmol, 73%).

¹H-NMR (CD₃OD, 600 MHz) δ (ppm): 1.64 (m, 2H), 1.79 (m, 2H), 1.95 (m, 8H), 3.07 (s, 6H), 3.30-3.41 (m, 8H), 4.09 (s, 4H), 4.78 (s, 4H)

¹³C-NMR (CD₃OD, 150 Hz) δ (ppm): 20.8, 22.4, 45.8, 59.0, 74.1, 92.8, 121 (q, J=319 Hz)

### <Compound E>

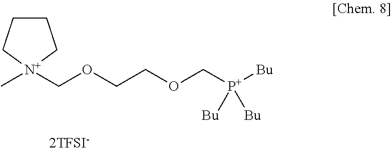

Compound E ([(Pyr₁)MEM(PBu₃)][2TFSI]) represented by the above formula was synthesized as follows.

After dissolving 1,2-bischloromethoxyethane (712 mg, 4.48 mmol) in tetrahydrofuran (1.5 mL) under an Ar atmosphere, N-methylpyrrolidine (384 mg, 4.51 mmol) was added dropwise at −10° C. for 10 minutes at a rate of 2.874 mL/h to stir thereafter at 35° C. for 5 minutes. After adding CH₃CN (3.0 mL), stirring was performed at 35° C. for 5 minutes, and thereafter tributylphosphine (1.07 g, 5.30 mmol) was added to stir at 35° C. for 5 hours. After distilling off the solvent, washing with diethyl ether and acetone was performed to vacuum dry, and thereafter [(Pyr₁)MEM(PBu₃)][2Cl](purity 90%) was obtained as a colorless and transparent liquid.

¹H-NMR (CD₃OD, 600 MHz) δ (ppm): 1.02-1.05 (m, 9H), 1.53-1.65 (m, 12H), 2.30-2.35 (m, 6H), 3.49 (m, 2H), 3.63 (m, 2H), 3.91 (m, 2H), 4.08 (m, 2H), 4.53 (d, J=5.4 Hz, 2H), 4.78 (s, 2H)

The obtained [(Pyr₁)MEM(PBu₃)][2Cl] (1.82 g, 4.08 mmol) and LiTFSI (3.27 g, 11.4 mmol) were dissolved in CH₃OH (25 mL) to stir at room temperature overnight. CH₃OH was distilled off. Thereafter, the product was dissolved in dichloromethane, washing with water was performed thereafter, and an organic phase was separated by liquid separation. Vacuum drying was performed to obtain a colorless and transparent liquid (3.33 g, purity 90%).

¹H-NMR (CD₃OD, 600 MHz) δ (ppm): 1.01-1.04 (m, 9H), 1.53-1.66 (m, 12H), 2.27-2.33 (m, 6H), 3.46-3.50 (m, 2H), 3.61-3.63 (m, 2H), 3.91-3.92 (m, 2H), 4.06-4.08 (m, 2H), 4.47-4.51 (d, J=5.3 Hz, 2H), 4.74 (s, 2H)

### <Compound F>

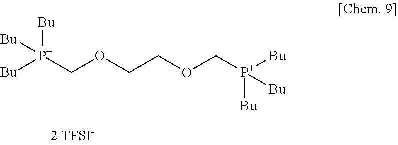

Compound F ([(PBu₃)₂MEM] [2TFSI]) represented by the above formula was synthesized as follows.

After dissolving 1,2-bischloromethoxyethane (2.49 g, 15.6 mmol) in CH₂Cl₂ (25 mL), tributylphosphine (6.43 g, 31.8 mmol) was added thereto to stir at room temperature overnight under an Ar atmosphere. After distilling off the solvent, washing with diethyl ether and vacuum drying were performed to obtain [(PBu₃)₂MEM] [2Cl](quant) as a white solid.

¹H-NMR (CD₃OD, 600 MHz) δ (ppm): 1.04 (t, J=7.26 Hz, 18H), 1.52-1.58 (m, 12H), 1.61-1.67 (m, 12H), 2.29-2.34 (m, 12H), 3.89 (s, 4H), 4.52 (s, 4H);

¹³C-NMR (CD₃OD, 150 Hz) δ (ppm): 13.9, 18.2 (d, J=46.5 Hz), 24.9 (d, J=84.0 Hz), 62.2 (d, J=64.5 Hz), 74.4

The obtained [(PBu₃)₂MEM] [2Cl] (3.76 g, 6.69 mmol) and LiTFSI (4.08 g, 14.2 mmol) were dissolved in CH₃OH (30 mL) to stir at room temperature overnight. CH₃OH was distilled off. Thereafter, the product was dissolved in dichloromethane, washing with water was performed thereafter, and an organic phase was separated by liquid separation. Vacuum drying was performed to obtain a yellow liquid (5.44 g, 5.17 mmol, 77%).

¹H-NMR (CD₃OD, 600 MHz) δ (ppm): 1.00 (t, J=7.26 Hz, 18H), 1.49-1.55 (m, 12H), 1.58-1.64 (m, 12H), 2.25-2.30 (m, 12H), 3.86 (s, 4H), 4.46 (s, 4H);

¹³C-NMR (CD₃OD, 150 Hz) δ (ppm): 14.0, 18.2 (d, J=46.5 Hz), 24.9 (d, J=85.5 Hz), 62.1 (d, J=64.5 Hz), 74.5, 122 (q, J=319 Hz)

### <Compound CA>

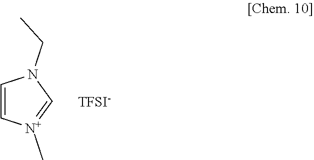

Compound CA (1-ethyl-3-methylimidazolium bis(trifluoromethylsulfonyl)imide, manufactured by IoLiTec GmbH) represented by the above formula was used.

### <Compound CB>

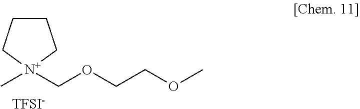

Compound CB ([Pyr₁MEM] [TFSI]) represented by the above formula was synthesized as follows.

After dissolving N-methylpyrrolidine (4.15 g, 48.7 mmol) in acetonitrile (25 mL) under an Ar atmosphere, 2-methoxyethoxymethyl chloride (6.09 g, 48.9 mmol) was added dropwise at 0° C. to stir thereafter at 0° C. for about 1 hour. After distilling off the solvent, activated carbon and ethanol were added to stir at room temperature for 15 hours. After removing the activated carbon by filtration, the solvent was distilled off, and drying was performed under reduced pressure to obtain [Pyr₁MEM] [Cl] (10.4 g, 49.6 mmol).

¹H-NMR (CD₃OD, 600 MHz) δ (ppm): 2.20-2.31 (m, 4H), 3.15 (s, 3H), 3.43 (s, 3H), 3.46-3.50 (m, 2H), 3.65 (t, J=4.2 Hz, 2H), 3.66-3.70 (m, 2H), 4.03 (t, J=4.2 Hz, 2H), 4.77 (s, 2H)

¹³C-NMR (CD₃OD, 150 Hz) δ (ppm): 623.2, 48.0, 59.3, 62.1, 72.9, 73.5, 91.3

The obtained [Pyr₁MEM][Cl] (10.4 g, 49.6 mmol) and LiTFSI (14.3 g, 49.8 mmol) were dissolved in water (60 mL) to stir at room temperature overnight. After extraction with methylene chloride, the obtained organic layer was washed with water. After the solvent was distilled off, activated carbon and ethanol were added to stir at room temperature for about 1 day. After removing the activated carbon by filtration, the solvent was distilled off, and furthermore, drying was performed under reduced pressure to obtain [Pyr₁MEM] [TFSI] (17.4 g, 38.2 mmol). Generation of the target product was confirmed by ¹H-NMR.

¹H-NMR (600 MHz, CDCl₃) δ (ppm): 2.20-2.30 (m, 4H), 3.12 (s, 3H), 3.38 (s, 3H), 3.40-3.44 (m, 2H), 3.58 (t, J=4.2 Hz, 2H), 3.66-3.70 (m, 2H), 3.97 (t, J=4.2 Hz, 2H), 4.69 (s, 2H);

¹³C-NMR (125 MHz, CDCl₃) δ (ppm): 22.0, 47.4, 58.8, 61.0, 71.4, 72.3, 89.8, 119.8 (q, J=321.1 Hz).

The term “TFSI⁻” represents bis(trifluoromethylsulfonyl)imide anion ([N(CF₃SO₂)₂]⁻).

### <Measurement of Ionic Conductivity>

The ionic conductivities of Compounds A to E at 25° C. were measured by an impedance method under the following conditions.

1. An evaluation cell of a coin-type lithium battery CR2032 was assembled in a glove box under a dry argon atmosphere. Specifically, each layer was laminated in the evaluation cell in the following order to produce a test laminate.

(Stainless steel plate/doughnut-shaped silicone sheet (outer circle 15 mmφ, inner circle diameter 5 mmφ, thickness 0.5 mm)/ionic liquid (injected into inner circle part of doughnut-shaped silicone sheet)/stainless steel plate)

2. Measurement was performed using an impedance measurement device at 25° C., frequency range of 0.1 Hz to 1 MHz, and applied voltage of 10 mV. The ionic conductivity a can be calculated using the following formula.

$$σ ( S \cdot {cm}^{- 1} ) = t ( cm ) \times R ( Ω ) / A ( {cm}^{2} )$$

In the formula, R represents the value of impedance. A represents the area of the sample. t represents the thickness of the sample.

### <Measurement of Potential Window>

Furthermore, measurement of potential windows (reference electrode: Ag/AgNO₃) was performed by putting about 1.0 mL of each of Compounds A to E and Compound CB into a triode cell (manufactured by TOYO Corporation) in a glove box purged with nitrogen to perform linear sweep voltammetry (scanning rate: 1 mV/s, sweep range: −4.0 V to reduction side and +4.0 V to oxidation side from open circuit potential, working electrode: glassy carbon (diameter: 3.0 mm), counter electrode: platinum wire (outer diameter: 0.5 mm)) under an argon atmosphere using a measurement device (ALS 700E electrochemical analyzer). After measurement, cyclic voltammetry was performed by adding ferrocene, and a potential obtained with the reference electrode was corrected by the oxidation-reduction potential of ferrocene. Potential windows were obtained by using each potential at which a current of 50 μA/cm² flowed at the time of the sweep to the reduction side and the oxidation side as the reduction potential and oxidation potential. The results are shown in Table 1.

TABLE 1

| | Ionic conductivity | Potential window |
|---|---|---|
| Compound | (mS/cm) | (V) |
| Compound A | 0.37 | −2.72 to 2.19 |
| Compound B | 0.25 | −2.83 to 2.45 |
| Compound C | 0.27 | −2.42 to 2.31 |
| Compound D | 0.11 | −2.69 to 2.30 |
| Compound E | 0.14 | −2.60 to 2.35 |
| Compound CB | 3.04 | −2.07 to 1.94 |

Table 1 shows that the dicationic ionic liquid of the present embodiment has a wider potential window than that of Compound CB that is a conventional ionic liquid. Furthermore, the dicationic ionic liquid of the present embodiment has a higher ionic conductivity than that of Compound CB that is a conventional ionic liquid.

### Examples A1 to A6 and Comparative Examples A1 to A3

LiTFSI was added to each ionic liquid such that the concentrations were as shown in Tables 2 and 3 to prepare composite electrolytes of Examples A1 to A6 and Comparative Examples A1 to A3.

### (Measurement of Limiting Current Density and Initial Current Density)

The limiting current density of the composite electrolyte prepared as described above was measured by a direct current test. In this test, a coin-type lithium battery CR2032 was used as an evaluation cell. Specifically, each layer was laminated in the evaluation cell in the following order to produce a test laminate.

(Stainless steel plate/metallic lithium foil/doughnut-shaped silicone sheet (outer circle 15 mmφ, inner circle diameter 5 mmφ, thickness 0.5 mm) and composite electrolyte injected into inner circle part of doughnut-shaped silicone sheet/metallic lithium foil)

The applied voltage to the above-mentioned evaluation cell was applied for 30 minutes to measure the change in current density over time. The current density was calculated by dividing the observed current by the inner circle area of the silicone sheet. The current density 30 minutes after the voltage application was denoted by I₃₀. I₃₀ was measured at each applied voltage by increasing the applied voltage stepwise, typically by 0.2 V. When the applied voltage was small, I₃₀ also increased as the applied voltage was increased. When the applied voltage was large to a certain extent, even when the applied voltage was increased, I₃₀ did not increase any further and remained at a constant value. The maximum value of I₃₀ at this time was denoted by a limiting current density Iₗᵢₘ. The measured limiting current density indicates the maximum current density that can flow when a steady applied voltage was applied to the composite electrolyte to be measured. The test temperature was 25° C. unless otherwise specified.

As an initial current density, a current density 1 second after a voltage at which the above-mentioned limiting current density is provided was applied was used.

TABLE 2

| | | Concentration | | | | |
|---|---|---|---|---|---|---|
| | | of lithium salt | Iᵢₙᵢ | Iₗᵢₘ | Iₗᵢₘ/Iᵢₙᵢ | Li⁺/all ions* |
| | Ionic liquid | (mol/kg) | (μA/cm²) | (μA/cm²) | (%) | (%) |
| Example A1 | Compound A | 0.5 | 647 | 102 | 16 | 8 |
| Example A2 | Compound A | 1.0 | 181 | 51 | 28 | 14 |
| Example A3 | Compound B | 0.5 | 308 | 51 | 17 | 8 |
| Example A4 | Compound C | 0.5 | 292 | 102 | 35 | 8 |
| Example A5 | Compound D | 0.5 | 161 | 51 | 32 | 8 |
| Example A6 | Compound E | 0.5 | 109 | 38 | 35 | 8 |

*“Li⁺/all ions” is the percentage of the number of moles of lithium ions to all ions contained in the composite electrolyte.

TABLE 3

| | | Concentration | Iᵢₙᵢ | Iₗᵢₘ | Iₗᵢₘ/Iᵢₙᵢ | Li⁺/all ions* |
|---|---|---|---|---|---|---|
| | Ionic liquid | (mol/kg) | (μA/cm²) | (μA/cm²) | (%) | (%) |
| Comparative | Compound CA | 0.5 | 4026 | 255 | 6 | 8 |
| Example A1 | | | | | | |
| Comparative | Compound CA | 1.0 | 6135 | 255 | 4 | 14 |
| Example A2 | | | | | | |
| Comparative | Compound CB | 0.5 | 4632 | 357 | 8 | 16 |
| Example A3 | | | | | | |

*“Li⁺/all ions” is the percentage of the number of moles of lithium ions to all ions contained in the composite electrolyte.

The contribution ratio of the current contributed by lithium ions to the total current was calculated by dividing the above-mentioned limiting current value by the initial current value. At the initial stage of voltage application, all ions contained in the electrolyte move and contribute to the current. At the time of the steady state for 30 minutes after voltage application, only lithium ions contribute to the current.

### Examples B1 to B5

Composite electrolytes of Examples B1 to B5 were prepared by mixing an ionic liquid, a lithium salt (LiTFSI), and a viscosity reducing agent with the compositions shown in Table 4. As the viscosity reducing agent, a mixed solvent of ethylene carbonate (EC) and propylene carbonate (PC) (volume ratio EC:PC=1:1) was added. The limiting current value of the ionic liquid electrolyte containing the viscosity reducing agent was verified by a direct current test. In this test, the same configuration as that of the above-mentioned test laminate was used except that the viscosity reducing agent was added to the composite electrolyte.

### (Measurement of Limiting Current Density and Initial Current Density)

A voltage of 0.1 V was continuously applied to the above-mentioned test laminate to observe the changes in current density over time. A value at which the current density did not change for 1 hour or longer was used as the limiting current density. The test temperature was 25° C.

As an initial current density, a current density 1 second after applying a voltage of 0.1 V was used.

The contribution ratio of the current contributed by lithium ions to the total current was corresponds to Iₗᵢₘ/Iᵢₙᵢ calculated by dividing the above-mentioned limiting current density by the initial current density. At the initial stage of voltage application, all ions contained in the electrolyte move and contribute to the current. At the time of the steady state for 30 minutes after voltage application, only lithium ions contribute to the current.

TABLE 4

| | | Mixed | | | | | |
|---|---|---|---|---|---|---|---|
| | | solvent | Concentration | | | | Li⁺/all |
| | | (% by | of lithium salt | Iᵢₙᵢ | Iₗᵢₘ | Iₗᵢₘ/Iᵢₙᵢ | ions* |
| | Ionic liquid | mass**) | (mol/kg) | (μA/cm²) | (μA/cm²) | (%) | (%) |
| Example | Compound | 25 | 0.4 | 912 | 255 | 28 | 8 |
| B1 | A | | | | | | |
| Example | Compound | 25 | 0.4 | 633 | 138 | 22 | 9 |
| B2 | B | | | | | | |
| Example | Compound | 25 | 0.65 | 478 | 132 | 28 | 14 |
| B3 | C | | | | | | |
| Example | Compound | 25 | 0.4 | 617 | 163 | 26 | 9 |
| B4 | D | | | | | | |
| Example | Compound | 25 | 0.4 | 353 | 97 | 27 | 9 |
| B5 | E | | | | | | |

*“Li⁺/all ions” is the percentage of the number of moles of lithium ions to all ions contained in the composite electrolyte.
**The content of the mixed solvent is % by mass with respect to 100% by mass of the ionic liquid.

### (Lithium Dissolution and Deposition Cycle Test)

As a sample, 0.125 mmol of a lithium salt, 250 mg of the ionic liquid, and 62.5 mg of a viscosity reducing agent (mixed solvent containing EC and PC at a volume ratio of 1:1) were mixed to prepare composite electrolytes of Examples B6 to B9 and Comparative Example B1. The ionic liquids contained in each of the composite electrolyte were as follows. The above-mentioned test laminate was produced using these composite electrolytes.
Example B6: Compound C
Example B7: Compound A
Example B8: Compound B
Example B9: Compound D
Example B10: Compound E
Comparative Example B1: Compound CA
Comparative Example B2: Compound CB
Example B11: Compound E′
Example B12: Compound A′
Example B13: Compound H′
Example B14: Compound B′

Lithium was deposited by flowing a current of +200 μA/cm² for 1 hour so that lithium was deposited on the metallic lithium foil in the above-mentioned test laminate. Thereafter, at an interval of 10 minutes, lithium was eluted by flowing a current of −200 μA/cm² for 1 hour so that lithium was eluted from the metallic lithium foil. At an interval of 10 minutes again, the above-mentioned deposition and elution of lithium was repeated. The behavior of the voltage value was observed to evaluate the stability of the voltage value over time. From the viewpoint of controlling the dissolution and deposition of lithium, it is desirable that the voltage fluctuation when flowing current be small and that the voltage be stable even after multiple times of repeated cycles.

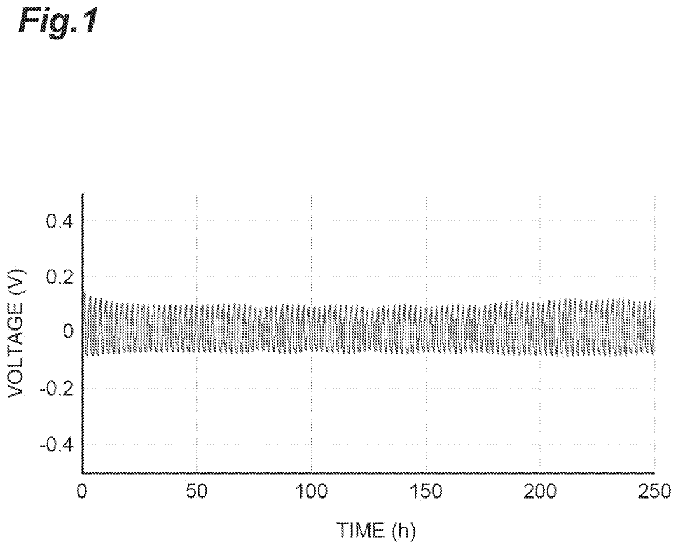

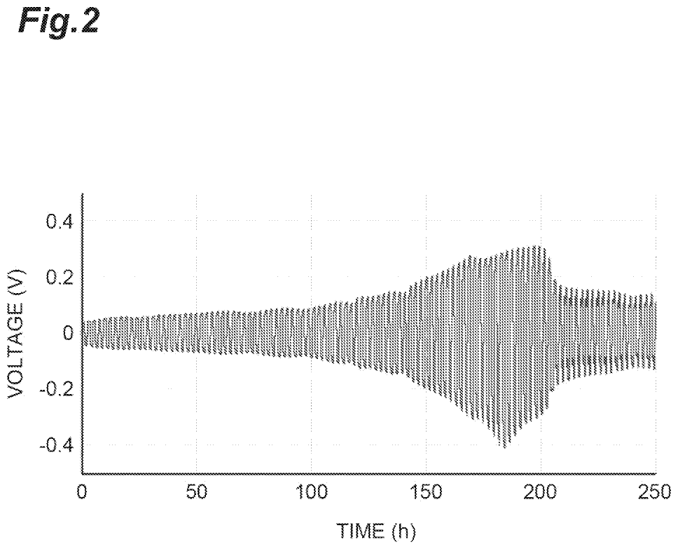

FIG. 1 is a diagram showing the results of the lithium dissolution and deposition cycle test of Example B6. Furthermore, FIG. 2 is a diagram showing the results of the lithium dissolution and deposition cycle test of Comparative Example B1. In FIGS. 1 and 2, the vertical axis is voltage (V), and the horizontal axis is time (h). As is clear from the comparison between FIG. 1 and FIG. 2, in the composite electrolyte of Example B6, even when the cycle test was repeated for 250 hours, the voltage fluctuation was small, and the amplitude of the fluctuation was approximately constant. On the other hand, as shown in FIG. 2, in the sample of Comparative Example B1, the voltage fluctuation became large after a lapse of about 100 hours, and the voltage fluctuation became even larger after a lapse of about 140 hours, showing that the cycle was not stable.

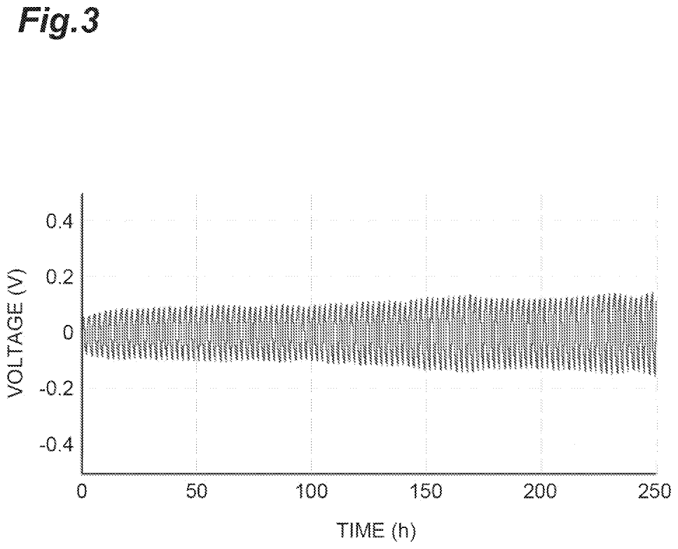

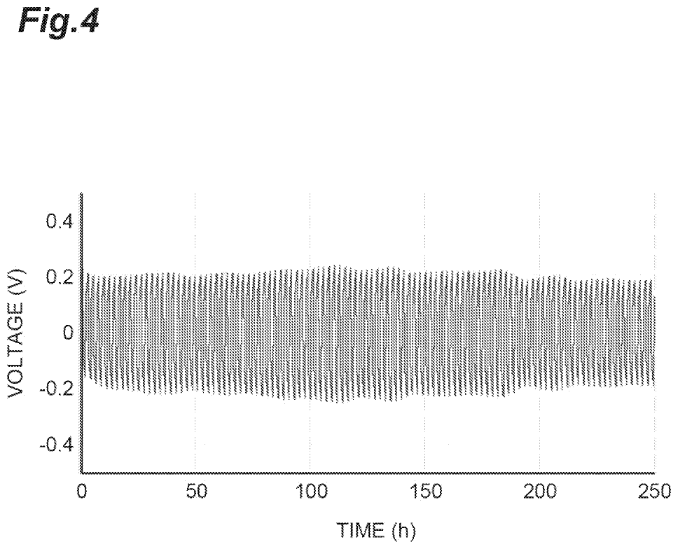

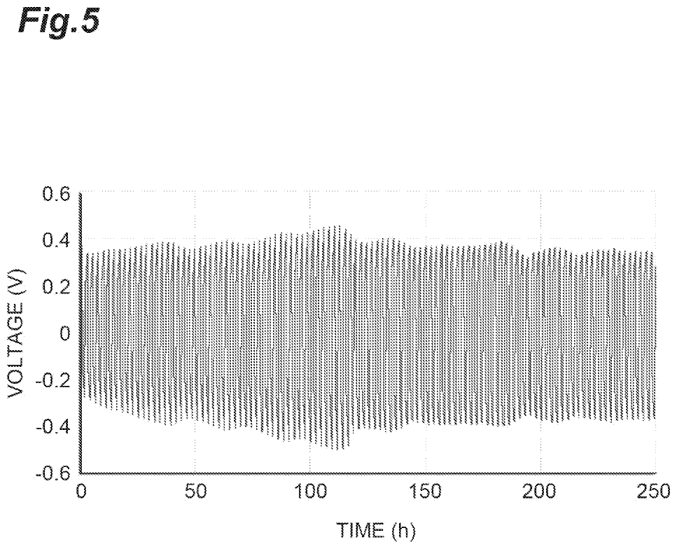

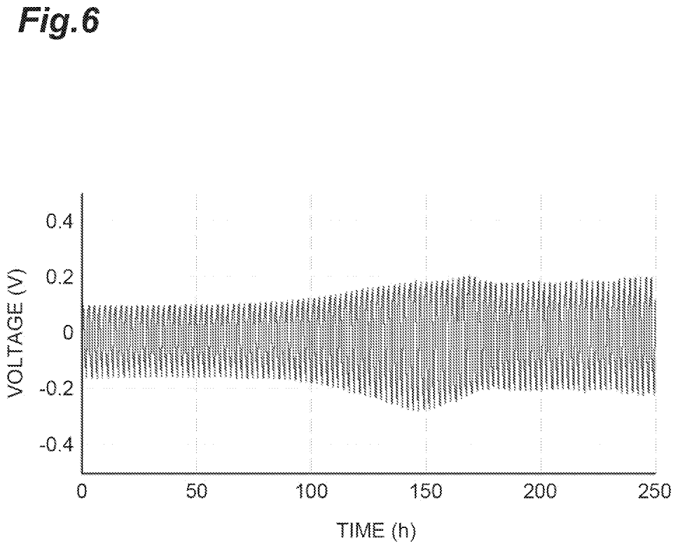

Similarly, FIGS. 3 to 7 are diagrams showing the results of the lithium dissolution and deposition cycle test of Examples B7 to B10 and Comparative Example B2, respectively. As shown in FIGS. 3 and 4, in the composite electrolytes of Examples B7 and 8, even when the cycle test was repeated for 250 hours, the voltage fluctuation was small, and the amplitude of the fluctuation was approximately constant. Furthermore, as shown in FIG. 5, in the composite electrolyte of Example B9, even when the cycle test was repeated for about 250 hours, the voltage fluctuation was small, and the amplitude of the fluctuation was approximately constant. Furthermore, as shown in FIG. 6, in the composite electrolyte of Example B10, even when the cycle test was repeated for about 250 hours, the voltage fluctuation was relatively small, and the amplitude of the fluctuation was approximately constant.

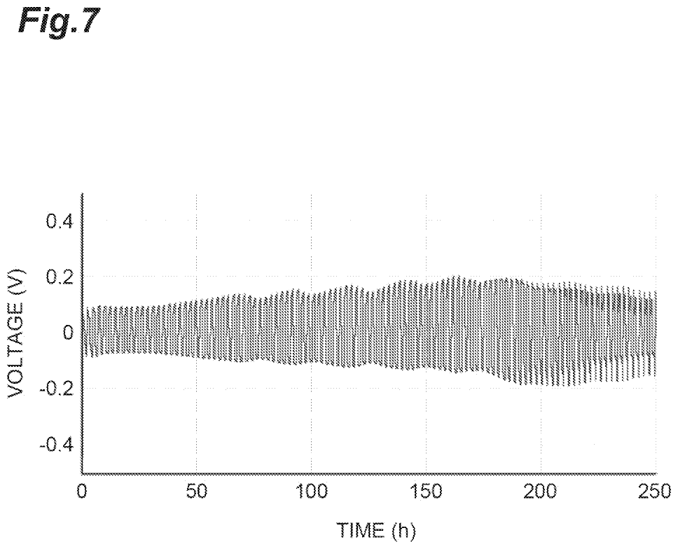

On the other hand, as shown in FIG. 7, in the composite electrolyte of Comparative Example B2, the voltage value continued to increase between 50 to 150 hours, and the voltage value was particularly unstable after 200 hours. In particular, in the range after 200 hours, the following behavior was repeated: the voltage changed rapidly immediately after flowing of +200 μA/cm² or −200 μA/cm², and the absolute value of the voltage immediately decreased thereafter to become approximately constant. Based on the above description, it was found that lithium dendrites were significantly deposited after 200 hours.

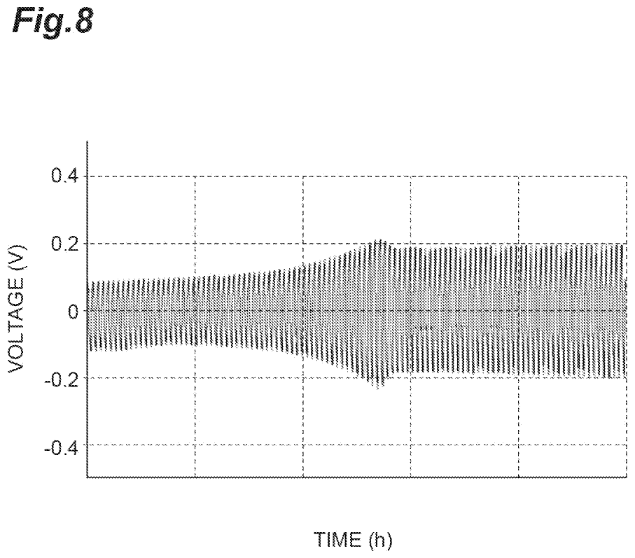

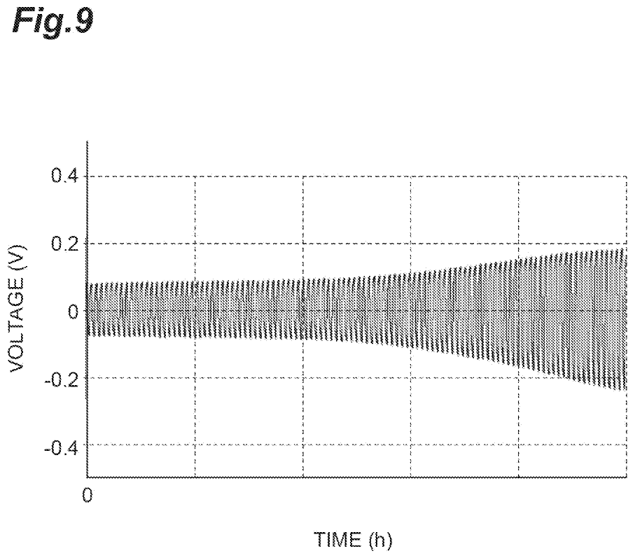

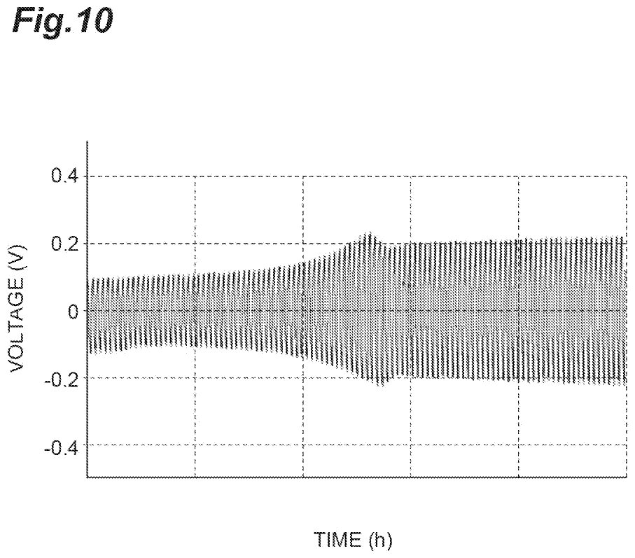

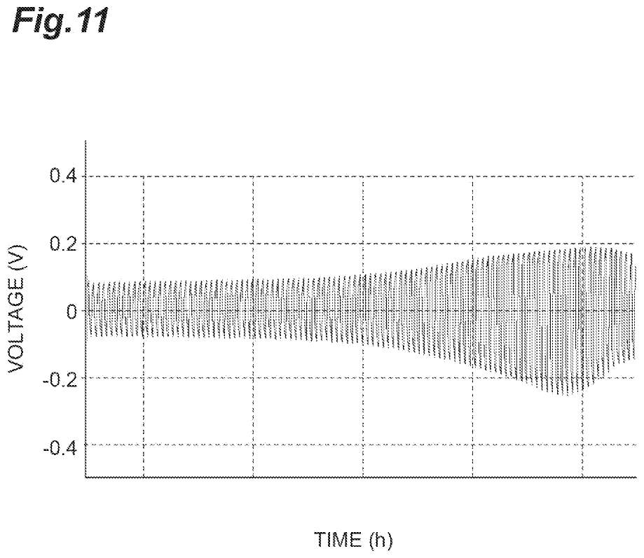

In addition, FIGS. 8 to 11 are diagrams showing the results of the lithium dissolution and deposition cycle test of Examples B11 to B14, respectively. As can be seen from FIGS. 8 to 11, also when the composite electrolytes of Examples B11 to B14 were used, even when the cycle test was repeated for about 250 hours, the voltage fluctuation was relatively small, and the amplitude of the fluctuation was approximately constant.

### (10% Weight Loss Temperature 1)

Regarding thermal analysis (TG-DTA), the 10% weight loss temperature (° C.) of Compounds A to F was measured using Thermo plus EVO II manufactured by Rigaku Corporation. Specifically, 3 to 5 mg of a sample was heated in an aluminum container under the conditions of a starting temperature of 40° C., a final temperature of 500° C., and a temperature rising rate of 5° C./minute. A temperature at which a weight reached 90% of an initial weight was used as a 10% weight loss temperature. The results are shown in Tables 5 and 6. Compound F was solid at room temperature (25° C.).

TABLE 5

| Compound | 10% Weight loss temperature (° C.) |
|---|---|
| Compound A | 320 |
| Compound B | 302 |
| Compound C | 318 |
| Compound D | 316 |
| Compound E | 340 |
| Compound F | 331 |

### (10% Weight Loss Temperature 2)

Regarding thermal analysis (TG-DTA), the 10% weight loss temperature (° C.) of Compounds A to F was measured using a simultaneous differential thermal and thermogravimetric analyzer DTG-60A of Shimadzu Corporation. Specifically, 3 to 5 mg of a sample was heated in an aluminum container from room temperature to 150° C. under the condition of a temperature rising rate of 10° C./minute, and 150° C. was maintained for 10 minutes. Thereafter, heating was performed from 150° C. to 350° C. under the condition of a temperature rising rate of 1° C./minutes, and heating was performed from 350° C. to 500° C. under the condition of a temperature rising rate of 10° C./minutes. A temperature at which a weight reached 90% of an initial weight was used as a 10% weight loss temperature. The results are shown in Table 6.

As shown in Table 5, the ionic liquid of the present embodiment can be said to have excellent heat resistance. In particular, a 10% weight loss temperature was improved in Compound E, which is asymmetric, as compared to Compounds A to D and Compound F, which are symmetric.

### <Compound A′>

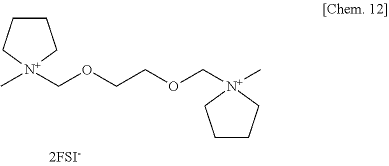

Compound A′ ([(Pyr₁)₂MEM][2FSI]) represented by the above formula was synthesized as follows.

After dissolving 1,2-bischloromethoxyethane (790 mg, 4.97 mmol) in CH₂Cl₂ (30 mL), N-methylpyrrolidine (961 mg, 11.3 mmol) was added thereto to stir at room temperature overnight under an Ar atmosphere. After distilling off the solvent, washing with diethyl ether and vacuum drying were performed to obtain [(Pyr₁)₂MEM] [2Cl](quant) as a white solid. The NMR data of the product is shown below. When the yield of a product is substantially 100%, this is written as quant.

¹H-NMR (CDCl₃, 600 MHz) δ (ppm): 2.22-2.35 (m, 8H), 3.36 (s, 6H), 3.65-3.69 (m, 4H), 3.93-3.97 (m, 4H), 4.23 (s, 4H), 5.47 (s, 4H)

¹³C-NMR (CD₃OD, 150 Hz) δ (ppm): 23.0, 48.4, 62.5, 73.6, 91.4

The obtained [(Pyr₁)₂MEM][2Cl] (1.98 g, 6.00 mmol) and LiFSI (2.30 g, 12.3 mmol) were dissolved in CH₃OH (50 mL) to stir at room temperature overnight. CH₃OH was distilled off. Thereafter, the product was dissolved in ethyl acetate, washing with water was performed thereafter, and an organic phase was separated by liquid separation. The organic phase was vacuum dried to obtain a colorless and transparent liquid (2.88 g, 4.66 mmol, 78%). The NMR data of the product is shown below. Unless otherwise specified, chemical shifts for ¹H-NMR and ¹³C-NMR are based on H or C of chloroform when a deuterated solvent used for measurement is deuterated chloroform (CDCl₃), and are based on H or C of a methyl group of methanol when a deuterated solvent is deuterated methanol (CD₃OD).

¹H-NMR (CD₃OD, 600 MHz) δ (ppm): 2.22-2.26 (m, 8H), 3.13 (s, 6H), 3.46-3.48 (m, 4H), 3.61-3.63 (m, 4H), 4.09 (s, 4H), 4.75 (s, 4H)

¹³C-NMR (CD₃OD, 150 Hz) δ (ppm): 23.0, 48.0, 62.2, 73.1, 91.1

### <Compound B′>

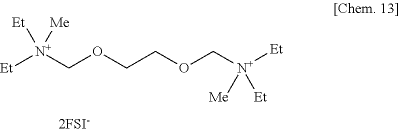 [SMILES: CC[N+](C)(CC)COCCOC[N+](C)(CC)CC]

Compound B′ ([(N₂₂₁)₂MEM][2FSI]) represented by the above formula was synthesized as follows.

After dissolving 1,2-bischloromethoxyethane (795 mg, 4.94 mmol) in CH₂Cl₂ (30 mL), N,N-diethylmethylamine (1.00 g, 11.5 mmol) was added thereto to stir at room temperature overnight under an Ar atmosphere. After distilling off the solvent, washing with diethyl ether and vacuum drying were performed to obtain [(N₂₂₁)₂MEM] [2Cl](quant) as a white solid. The NMR data of the product is shown below.

¹H-NMR (CDCl₃, 600 MHz) δ (ppm): 1.42 (t, J=17.5 Hz, 12H), 3.26 (s, 6H), 3.56-3.62 (m, 8H), 4.24 (s, 4H), 5.40 (s, 4H)

¹³C-NMR (CD₃OD, 150 Hz) δ (ppm): 8.19, 45.1, 55.2, 73.3, 89.0

The obtained [(N₂₂₁)₂MEM] [2Cl] (2.18 g, 6.54 mmol) and LiFSI (2.80 g, 14.9 mmol) were dissolved in CH₃OH (50 mL) to stir at room temperature overnight. CH₃OH was distilled off. Thereafter, the product was dissolved in ethyl acetate, washing with water was performed thereafter, and an organic phase was separated by liquid separation. The organic phase was vacuum dried to obtain a colorless and transparent liquid (3.18 g, 5.10 mmol, 78%). The NMR data of the product is shown below.

¹H-NMR (CD₃OD, 600 MHz) δ (ppm): 1.32-1.37 (m, 12H), 2.99 (s, 6H), 3.36-3.42 (m, 12H), 4.06 (s, 4H), 4.72 (s, 4H)

¹³C-NMR (CD₃OD, 150 Hz) δ (ppm): 7.50, 44.4, 51.5, 72.7, 88.4

### <Compound C′>

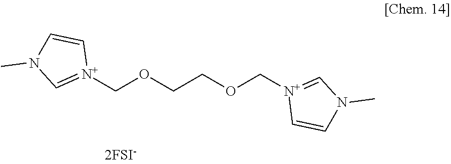

Compound I ([(Mim)₂MEM] [2FSI]) represented by the above formula was synthesized as follows.

After dissolving 1,2-bischloromethoxyethane (2.23 g, 14.0 mmol) in CH₂Cl₂ (20 mL), N-methylimidazole (2.49 g, 30.3 mmol) was added thereto to stir at room temperature overnight under an Ar atmosphere. After distilling off the solvent, washing with diethyl ether and vacuum drying were performed to obtain [(Mim)₂MEM] [2Cl](quant) as a white solid.

¹H-NMR (CD₃OD, 600 MHz) δ (ppm): 3.81 (s, 4H), 4.03 (s, 6H), 5.69 (s, 4H), 7.70 (s, 2H), 7.81 (s, 2H), 9.23 (s, 2H)

The obtained [(Mim)₂MEM] [2Cl] (2.83 g, 8.75 mmol) and LiFSI (3.49 g, 18.6 mmol) were dissolved in CH₃OH (50 mL) to stir at room temperature overnight. CH₃OH was distilled off. Thereafter, the product was dissolved in ethyl acetate, washing with water was performed thereafter, and an organic phase was separated by liquid separation. The organic phase was vacuum dried to obtain a colorless and transparent liquid (3.70 g, 6.04 mmol, 69%).

¹H-NMR (CDCl₃, 600 MHz) δ (ppm): 3.76 (s, 4H), 3.97 (s, 6H), 5.60 (s, 4H), 7.64 (s, 2H), 7.72 (s, 2H), 9.04 (s, 2H)

¹³C-NMR (CD₃OD, 150 Hz) δ (ppm): 36.6, 69.9, 80.1, 122.9, 125.3, 138.0

### <Compound D′>

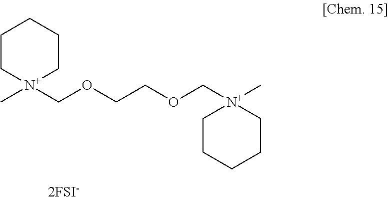 [SMILES: C[N+]1(COCCOC[N+]2(C)CCCCC2)CCCCC1]

Compound D′ ([(Pip₁)₂MEM] [2FSI]) represented by the above formula was synthesized as follows.

After dissolving 1,2-bischloromethoxyethane (1.63 g, 10.2 mmol) in CH₂Cl₂ (30 mL), N-methylpiperidine (2.10 g, 21.2 mmol) was added thereto to stir at room temperature overnight under an Ar atmosphere. After distilling off the solvent, washing with diethyl ether and vacuum drying were performed to obtain [(Pip)₂MEM] [2Cl](quant) as a white solid.

¹H-NMR (CDCl₃, 600 MHz) δ (ppm): 1.70-1.74 (m, 4H), 1.86-1.97 (m, 16H), 3.33 (s, 6H), 4.24 (s, 4H), 5.53 (s, 4H)

¹³C-NMR (CD₃OD, 150 Hz) δ (ppm): 20.9, 22.6, 45.7, 58.9, 74.2, 92.7

The obtained [(Pip)₂MEM] [2Cl] (3.66 g, 10.2 mmol) and LiFSI (3.99 g, 21.3 mmol) were dissolved in CH₃OH (30 mL) to stir at room temperature overnight. CH₃OH was distilled off. Thereafter, the product was dissolved in dichloromethane, washing with water was performed thereafter, and an organic phase was separated by liquid separation. The organic phase was vacuum dried to obtain a colorless and transparent liquid (4.28 g, 6.62 mmol, 65%).

¹H-NMR (CD₃OD, 600 MHz) δ (ppm): 1.62-1.68 (m, 2H), 1.78-1.82 (m, 2H), 1.92-2.00 (m, 8H), 3.08 (s, 6H), 3.33-3.42 (s, 8H), 4.10 (s, 4H), 4.78 (s, 4H)

¹³C-NMR (CD₃OD, 150 Hz) δ (ppm): 20.4, 22.1, 45.4, 58.6, 73.7, 92.4

### <Compound E′>

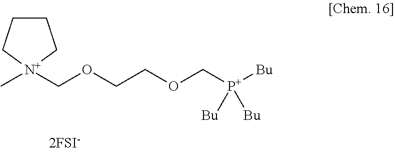

Compound E′ ([(Pyr₁)MEM(PBu₃)][2FSI]) represented by the above formula was synthesized as follows.

After dissolving 1,2-bischloromethoxyethane (715 mg, 4.50 mmol) in ethyl acetate (1.5 mL) under an Ar atmosphere, N-methylpyrrolidine (382 mg, 4.48 mmol) was added dropwise at −10° C. at a rate of 2.874 mL/h to stir thereafter at −10° C. for 2 minutes, and continuously at 35° C. for 5 minutes. After adding CH₃CN (3.0 mL), stirring was performed at 35° C. for 5 minutes, and thereafter tributylphosphine (1.09 g, 5.38 mmol) was added to stir at 35° C. for 5 hours. After distilling off the solvent, washing with diethyl ether and acetone was performed to vacuum dry, and thereafter [(Pyr₁)MEM(PBu₃)][2Cl](purity 93%) was obtained as a colorless and transparent liquid.

¹H-NMR (CD₃OD, 600 MHz) δ (ppm): 1.02-1.05 (m, 9H), 1.53-1.65 (m, 12H), 2.30-2.35 (m, 6H), 3.45-3.50 (m, 2H), 3.61-3.65 (m, 2H), 3.89-3.91 (m, 2H), 4.06-4.08 (m, 2H), 4.53 (d, J=5.4 Hz, 2H), 4.78 (s, 2H)

¹³C-NMR (CD₃OD, 150 Hz) δ (ppm): 13.6, 17.7, 18.0, 23.1, 24.18, 24.25, 24.28, 24.8, 24.9, 48.0, 61.7, 62.1, 72.9, 74.16, 74.24, 91.0

The obtained [(Pyr₁)MEM(PBu₃)][2Cl] (748 mg, 1.67 mmol) and LiFSI (876 mg, 4.68 mmol) were dissolved in CH₃OH (30 mL) to stir at room temperature overnight. CH₃OH was distilled off. Thereafter, the product was dissolved in ethyl acetate, washing with water was performed thereafter, and an organic phase was separated by liquid separation. Vacuum drying was performed to obtain a colorless and transparent liquid (1.09 g, purity 92%).

¹H-NMR (CD₃OD, 600 MHz) δ (ppm): 1.01 (t, J=7.2 Hz, 9H), 1.50-1.56 (m, 6H), 1.59-1.65 (m, 6H), 2.21-2.31 (m, 10H), 3.12 (s, 3H), 3.44-3.49 (m, 2H), 3.59-3.63 (m, 2H), 3.89-3.90 (m, 2H), 4.05-4.06 (m, 2H), 4.48 (d, J=5.4 Hz, 2H), 4.72 (s, 2H)

¹³C-NMR (CD₃OD, 150 Hz) δ (ppm): 13.5, 17.6, 17.9, 23.1, 24.17, 24.20, 24.8, 24.9, 48.0, 61.5, 62.2, 72.9, 74.2, 74.3, 91.0

### <Compound G>

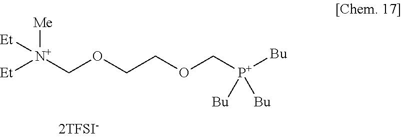

Compound G ([(N₂₂₁)MEM(PBu₃)][2TFSI]) represented by the above formula was synthesized as follows.

After dissolving 1,2-bischloromethoxyethane (1.91 g, 12.0 mmol) in THF (4.0 mL) under an Ar atmosphere, N,N-diethylmethylamine (1.05 g, 12.1 mmol) was added dropwise at −10° C. at a rate of 2.90 mL/h to stir thereafter at −10° C. for 2 minutes, and to stir continuously at 35° C. for 5 minutes. After adding CH₃CN (8.0 mL), stirring was performed at 35° C. for 5 minutes, and thereafter tributylphosphine (2.93 g, 14.5 mmol) was added to stir at 35° C. for 5 hours. After distilling off the solvent, washing with diethyl ether and acetone was performed to perform gel filtration and vacuum dry, and thereafter [(N₂₂₁)MEM(PBu₃)][2Cl](purity 93%) was obtained as a colorless and transparent liquid.

¹H-NMR (CD₃OD, 600 MHz) δ (ppm): 1.03-1.06 (m, 9H), 1.40 (t, J=7.2 Hz, 6H), 1.54-1.60 (m, 6H), 1.63-1.70 (m, 6H), 2.34-2.39 (m, 6H), 3.05 (m, 3H), 3.42-3.49 (m, 4H), 3.93-3.95 (m, 2H), 4.08-4.12 (m, 2H), 4.59 (d, J=5.4 Hz, 2H), 4.80 (s, 2H)

¹³C-NMR (CD₃OD, 150 Hz) δ (ppm): 7.8, 13.6, 17.7, 18.0, 24.26, 24.29, 24.8, 25.0, 44.8, 54.9, 61.7, 62.1, 72.8, 74.1, 74.2, 86.6

The obtained [(N₂₂₁)MEM(PBu₃)][2Cl] (916 mg, 2.04 mmol) and LiTFSI (1.21 g, 4.21 mmol) were dissolved in CH₃OH (30 mL) to stir at room temperature overnight. CH₃OH was distilled off. Thereafter, the product was dissolved in methylene chloride, washing with water was performed thereafter, and an organic phase was separated by liquid separation. Vacuum drying was performed to obtain a colorless and transparent liquid (1.03 g, purity 96%).

¹H-NMR (CD₃OD, 600 MHz) δ (ppm): 1.05 (t, J=7.3 Hz, 9H), 1.40 (t, J=7.3 Hz, 6H), 1.55-1.59 (m, 6H), 1.64-1.67 (m, 6H), 2.30-2.35 (m, 6H), 3.03 (s, 3H), 3.35-3.45 (m, 4H), 3.93-3.94 (m, 2H), 4.06-4.08 (m, 2H), 4.52 (d, J=5.3 Hz, 2H), 4.73 (s, 2H)

¹³C-NMR (CD₃OD, 150 Hz) δ (ppm): 7.7, 13.5, 17.6, 17.9, 24.19, 24.22, 24.8, 24.9, 44.7, 55.0, 61.6, 62.0, 72.7, 74.1, 74.2, 86.6, 121.1 (q, J=319 Hz)

### <Compound G′>

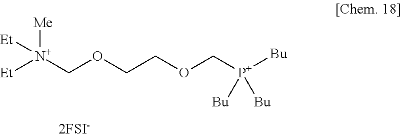

Compound G′ ([(N₂₂₁)MEM(PBu₃)][2FSI]) represented by the above formula was synthesized as follows.

After dissolving 1,2-bischloromethoxyethane (621 mg, 3.91 mmol) in tetrahydrofuran (1.3 mL) under an Ar atmosphere, N,N-diethylmethylamine (356 mg, 4.09 mmol) was added dropwise at −10° C. at a rate of 2.874 mL/h to stir thereafter at −10° C. for 2 minutes, and to stir continuously at 35° C. for 5 minutes. After adding CH₃CN (2.6 mL), stirring was performed at 35° C. for 5 minutes, and thereafter tributylphosphine (817 mg, 4.04 mmol) was added to stir at 35° C. for 5 hours. After distilling off the solvent, washing with diethyl ether and acetone was performed to perform gel filtration and vacuum dry, and thereafter [(N₂₂₁)MEM(PBu₃)][2Cl](purity 92%) was obtained as a colorless and transparent liquid.

¹H-NMR (CD₃OD, 600 MHz) δ (ppm): 1.03-1.06 (m, 9H), 1.40 (t, J=7.2 Hz, 6H), 1.54-1.60 (m, 6H), 1.63-1.70 (m, 6H), 2.34-2.39 (m, 6H), 3.05 (m, 3H), 3.42-3.49 (m, 4H), 3.93-3.95 (m, 2H), 4.08-4.12 (m, 2H), 4.59 (d, J=5.4 Hz, 2H), 4.80 (s, 2H)

¹³C-NMR (CD₃OD, 150 Hz) δ (ppm): 7.8, 13.6, 17.7, 18.0, 24.26, 24.29, 24.8, 25.0, 44.8, 54.9, 61.7, 62.1, 72.8, 74.1, 74.2, 86.6

The obtained [(N₂₂₁)MEM(PBu₃)][2Cl] (778 mg, 1.74 mmol) and LiFSI (751 mg, 4.02 mmol) were dissolved in CH₃OH (30 mL) to stir at room temperature overnight. CH₃OH was distilled off. Thereafter, the product was dissolved in methylene chloride, washing with water was performed thereafter, and an organic phase was separated by liquid separation. Vacuum drying was performed to obtain a colorless and transparent liquid (781 mg, purity 99%).

¹H-NMR (CD₃OD, 600 MHz) δ (ppm): 1.00 (t, J=7.2 Hz, 9H), 1.35 (t, J=7.2 Hz, 6H), 1.49-1.55 (m, 6H), 1.58-1.65 (m, 6H), 2.25-2.30 (m, 6H), 2.98 (s, 3H), 3.35-3.42 (m, 4H), 3.88-3.89 (m, 2H), 4.02-4.03 (m, 2H), 4.47 (d, J=5.4 Hz, 2H), 4.68 (s, 2H)

¹³C-NMR (CD₃OD, 150 Hz) δ (ppm): 7.7, 13.5, 17.6, 17.9, 24.18, 24.21, 24.8, 24.9, 44.7, 55.0, 61.5, 62.0, 72.8, 74.1, 74.2, 86.6

### <Compound H>

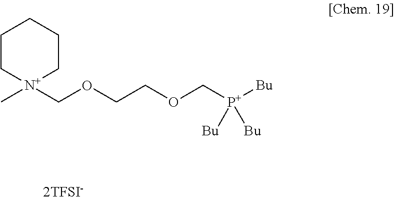

Compound H ([(Pip₁)MEM(PBu₃)][2TFSI]) represented by the above formula was synthesized as follows.

After dissolving 1,2-bischloromethoxyethane (1.43 g, 9.02 mmol) in tetrahydrofuran (3.0 mL) under an Ar atmosphere, N-methylpiperidine (867 mg, 8.74 mmol) was added dropwise at 0° C. at a rate of 2.90 mL/h to stir thereafter at 0° C. for 2 minutes, and to stir continuously at 35° C. for 30 minutes. After adding CH₃CN (6.0 mL), stirring was performed at 35° C. for 5 minutes, and thereafter tributylphosphine (2.18 g, 10.8 mmol) was added to stir at 35° C. for 4.5 hours. After distilling off the solvent, washing with diethyl ether and acetone was performed to perform gel filtration and vacuum dry, and thereafter [(Pip₁)MEM(PBu₃)][2Cl](purity 91%) was obtained as a colorless and transparent liquid.

¹H-NMR (CD₃OD, 600 MHz) δ (ppm): 1.05 (t, J=7.2 Hz, 9H), 1.52-1.60 (m, 6H), 1.60-1.72 (m, 7H), 1.81-1.84 (m, 1H), 1.95-2.02 (m, 4H), 2.32-2.37 (m, 6H), 3.13 (s, 3H), 3.38-3.49 (m, 4H), 3.93-3.94 (m, 2H), 4.11-4.13 (m, 2H), 4.49 (d, J=5.4 Hz, 2H), 4.87 (s, 2H)

¹³C-NMR (CD₃OD, 150 Hz) δ (ppm): 13.6, 17.7, 18.0, 20.5, 22.2, 24.3, 24.8, 25.0, 45.3, 58.5, 61.7, 62.1, 73.5, 74.2, 74.3

The obtained [(Pip₁)MEM(PBu₃)][2Cl] (2.12 g, 4.60 mmol) and LiTFSI (2.84 g, 9.89 mmol) were dissolved in CH₃OH (20 mL) to stir at room temperature overnight. CH₃OH was distilled off. Thereafter, the product was dissolved in methylene chloride, washing with water was performed thereafter, and an organic phase was separated by liquid separation. Vacuum drying was performed to obtain a colorless and transparent liquid (2.80 g, purity 93%).

¹H-NMR (CD₃OD, 600 MHz) δ (ppm): 1.03 (t, J=7.2 Hz, 9H), 1.52-1.58 (m, 6H), 1.61-1.70 (m, 7H), 1.81-1.84 (m, 1H), 1.91-2.02 (m, 4H), 2.28-2.34 (m, 6H), 3.10 (s, 3H), 3.34-3.44 (m, 4H), 3.91-3.93 (m, 2H), 4.08-4.09 (m, 2H), 4.51 (d, J=5.4 Hz, 2H), 4.78 (s, 2H)

¹³C-NMR (CD₃OD, 150 Hz) δ (ppm): 13.5, 17.6, 17.9, 20.4, 22.1, 24.2, 24.8, 24.9, 45.4, 58.6, 61.6, 62.0, 73.5, 74.2, 92.3, 121.1 (q, J=318 Hz)

### <Compound H′>

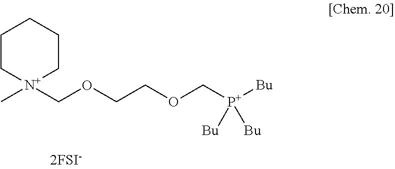

Compound I ([(Pip₁)MEM(PBu₃)][2FSI]) represented by the above formula was synthesized as follows.

After dissolving 1,2-bischloromethoxyethane (1.44 g, 9.04 mmol) in tetrahydrofuran (3.0 mL) under an Ar atmosphere, N-methylpiperidine (841 mg, 8.48 mmol) was added dropwise at −10° C. at a rate of 2.90 mL/h to stir thereafter at 0° C. for 2 minutes, and to stir continuously at 35° C. for 30 minutes. After adding CH₃CN (6.0 mL), stirring was performed at 35° C. for 5 minutes, and thereafter tributylphosphine (2.16 g, 10.7 mmol) was added to stir at 35° C. for 5 hours. After distilling off the solvent, washing with diethyl ether and acetone was performed to perform gel filtration and vacuum dry, and thereafter [(Pip₁)MEM(PBu₃)][2Cl](purity 88%) was obtained as a colorless and transparent liquid.

¹H-NMR (CD₃OD, 600 MHz) δ (ppm): 1.05 (t, J=7.2 Hz, 9H), 1.52-1.60 (m, 6H), 1.60-1.72 (m, 7H), 1.81-1.84 (m, 1H), 1.95-2.02 (m, 4H), 2.32-2.37 (m, 6H), 3.13 (s, 3H), 3.38-3.49 (m, 4H), 3.93-3.94 (m, 2H), 4.11-4.13 (m, 2H), 4.49 (d, J=5.4 Hz, 2H), 4.87 (s, 2H)

¹³C-NMR (CD₃OD, 150 Hz) δ (ppm): ¹³C-NMR (CD₃OD, 150 Hz) δ (ppm): 13.6, 17.7, 18.0, 20.5, 22.2, 24.3, 24.8, 25.0, 45.3, 58.5, 61.7, 62.1, 73.5, 74.2, 74.3

The obtained [(Pip₁)MEM(PBu₃)][2Cl] (1.24 g, 2.70 mmol) and LiFSI (1.08 g, 5.76 mmol) were dissolved in CH₃OH (30 mL) to stir at room temperature overnight. CH₃OH was distilled off. Thereafter, the product was dissolved in methylene chloride, washing with water was performed thereafter, and an organic phase was separated by liquid separation. Vacuum drying was performed to obtain a colorless and transparent liquid (2.10 g, purity 93%).

¹H-NMR (CD₃OD, 600 MHz) δ (ppm): 1.03 (t, J=7.2 Hz, 9H), 1.52-1.60 (m, 6H), 1.60-1.70 (m, 6H), 1.80-1.84 (m, 1H), 1.94-2.01 (m, 4H), 2.27-2.31 (m, 6H), 3.10 (s, 3H), 3.35-3.44 (m, 4H), 3.91-3.93 (m, 2H), 4.08-4.10 (m, 2H), 4.49 (d, J=5.4 Hz, 2H), 4.76 (s, 2H)

¹³C-NMR (CD₃OD, 150 Hz) δ (ppm): 13.5, 17.6, 17.9, 20.4, 22.0, 24.1, 24.8, 45.4, 58.6, 61.5, 61.9, 73.5, 74.1, 74.2, 92.2

### <Compound F′>

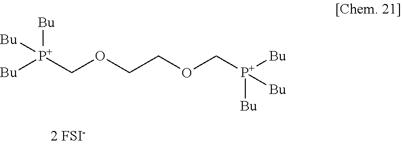

Compound F′ (PBu₃)₂MEM] [2TFSI]) represented by the above formula was synthesized as follows.

After dissolving 1,2-bischloromethoxyethane (2.30 g, 14.5 mmol) in CH₂Cl₂ (25 mL), tributylphosphine (6.39 g, 31.6 mmol) was added thereto to stir at room temperature overnight under an Ar atmosphere. After distilling off the solvent, washing with diethyl ether and vacuum drying were performed to obtain [(PBu₃)₂MEM] [2Cl](quant) as a white solid.

¹H-NMR (CD₃OD, 600 MHz) δ (ppm): 1.04 (t, J=7.26 Hz, 18H), 1.52-1.58 (m, 12H), 1.61-1.67 (m, 12H), 2.29-2.34 (m, 12H), 3.89 (s, 4H), 4.52 (s, 4H);

¹³C-NMR (CD₃OD, 150 Hz) δ (ppm): 13.9, 18.2 (d, J=46.5 Hz), 24.9 (d, J=84.0 Hz), 62.2 (d, J=64.5 Hz), 74.4

The obtained [(PBu₃)₂MEM] [2Cl] (2.86 g, 5.09 mmol) and LiFSI (2.49 g, 13.3 mmol) were dissolved in CH₃OH (50 mL) to stir at room temperature overnight. CH₃OH was distilled off. Thereafter, the product was dissolved in ethyl acetate, washing with water was performed thereafter, and an organic phase was separated by liquid separation. Vacuum drying was performed to obtain a white solid (quant).

¹H-NMR (CD₃OD, 600 MHz) δ (ppm): 1.01 (t, J=7.2 Hz, 18H), 1.51-1.56 (m, 12H), 1.58-1.64 (m, 12H), 2.25-2.30 (m, 12H), 3.87 (s, 4H), 4.46 (d, J=4.8 Hz, 4H);

¹³C-NMR (CD₃OD, 150 Hz) δ (ppm): 13.6, 17.6, 17.9, 24.19, 24.22, 24.8, 24.9, 61.5, 62.0, 74.2, 74.3

### <Compound CB′>

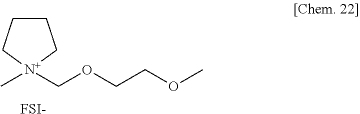

Compound CB′ ([Pyr₁MEM][FSI]) represented by the above formula was synthesized as follows.

After dissolving N-methylpyrrolidine (4.36 g, 51.1 mmol) in acetonitrile (25 mL) under an Ar atmosphere, 2-methoxyethoxymethyl chloride (6.54 g, 52.5 mmol) was added dropwise at 0° C. to stir thereafter at 0° C. overnight. After distilling off the solvent, activated carbon and methanol were added to stir at room temperature. After removing the activated carbon by filtration, the solvent was distilled off, and drying was performed under reduced pressure to obtain [Pyr₁MEM][Cl] (12.3 g, quant).

¹H-NMR (CD₃OD, 600 MHz) δ (ppm): 2.20-2.31 (m, 4H), 3.15 (s, 3H), 3.43 (s, 3H), 3.46-3.50 (m, 2H), 3.65 (t, J=4.2 Hz, 2H), 3.66-3.70 (m, 2H), 4.03 (t, J=4.2 Hz, 2H), 4.77 (s, 2H)

¹³C-NMR (CD₃OD, 150 Hz) δ (ppm): 623.2, 48.0, 59.3, 62.1, 72.9, 73.5, 91.3

The obtained [Pyr₁MEM][Cl] (4.2 g, 20.0 mmol) and LiFSI (13.9 g, 21.1 mmol) were dissolved in methanol (30 mL) to stir at room temperature for 21 hours. After extraction with methylene chloride, the obtained organic layer was washed with water. Thereafter, drying was performed under reduced pressure to obtain [Pyr₁MEM][FSI] (2.76 g, 7.79 mmol). Generation of the target product was confirmed by ¹H-NMR.

¹H-NMR (600 MHz, CDCl₃) δ (ppm): 2.25-2.32 (m, 4H), 3.14 (s, 3H), 3.39 (s, 3H), 3.40-3.45 (m, 2H), 3.59 (t, J=4.2 Hz, 2H), 3.68-3.71 (m, 2H), 3.99 (t, J=4.2 Hz, 2H), 4.70 (s, 2H)

The term “FSI⁻” represents bis(fluorosulfonyl)imide anion ([N(FSO₂)₂]⁻).

Compounds A′ to H′ and Compounds G and H were also measured for an ionic conductivity, a potential window, and a 10% weight loss temperature by the above-mentioned methods. The results are shown in Table 6.

TABLE 6

| | σ at | Potential | 10% Weight loss | 10% Weight loss |
|---|---|---|---|---|
| Compound | 25° C. | window | temperature 2 | temperature 1 |
| No. | [mS/cm] | (V vs. Fc/Fc⁺) | (° C.) | (° C.) |
| A | 0.37 | −2.72 to 2.19 | 276 | 320 |
| A′ | 0.97 | −2.72 to 2.26 | 221 | |
| B | 0.25 | −2.83 to 2.45 | 258 | 302 |
| B′ | 0.78 | −2.91 to 2.41 | 218 | |
| C | 0.27 | −2.42 to 2.31 | 248 | 318 |
| C′ | — | | | |
| D | 0.11 | −2.69 to 2.30 | 268 | 316 |
| D′ | — | −2.89 to 2.20 | 227 | |
| E | 0.14 | −2.60 to 2.35 | 280 | 340 |
| E′ | 0.42 | −2.83 to 2.27 | 222 | |
| G | — | −2.96 to 2.02 | 286 | |
| G′ | — | −2.64 to 2.28 | 224 | |
| H | — | −2.94 to 2.24 | 279 | |
| H′ | 0.22 | −2.70 to 2.13 | 229 | |
| CB | 3.04 | −2.07 to 1.94 | | |
| | — | −2.15 to 1.88 | | |

A composite electrolyte having the composition shown in Table 7 was prepared in the same manner as in Example A1 to measure Iᵢₙᵢ and Iₗᵢₘ in the same manner as in Example A1. The results are shown in Table 7. Furthermore, a composite electrolyte having the composition shown in Table 8 was prepared in the same manner as in Example B1 to measure Iᵢₙᵢ and Iₗᵢₘ in the same manner as in Example B1. The results are shown in Table 8.

TABLE 7

| | | Concentration | | | | | Li⁺/all |
|---|---|---|---|---|---|---|---|
| | | of lithium salt | Iᵢₙᵢ | Iₗᵢₘ | Voltage | Iₗᵢₘ/Iᵢₙᵢ | ions* |
| | Ionic liquid | (mol/kg) | (μA/cm²) | (μA/cm²) | (V) | (%) | (%) |
| Example | Compound | 0.5 | 647 | 102 | 0.7 | 16 | 8 |
| A1 | A | | | | | | |
| Example | Compound | 1.0 | 181 | 51 | 0.4 | 28 | 14 |
| A2 | A | | | | | | |
| Example | Compound | 0.5 | 1013 | 275 | 0.4 | 27 | 8 |
| A7 | A′ | | | | | | |
| Example | Compound | 0.5 | 308 | 51 | 0.6 | 17 | 8 |
| A3 | B | | | | | | |
| Example | Compound | 0.5 | 1149 | 387 | 0.4 | 34 | 8 |
| A8 | B′ | | | | | | |
| Example | Compound | 0.5 | 292 | 102 | 0.4 | 35 | 8 |
| A4 | C | | | | | | |
| Example | Compound | 0.5 | 161 | 51 | 0.4 | 32 | 8 |
| A5 | D | | | | | | |
| Example | Compound | 0.5 | 109 | 38 | 0.7 | 35 | 8 |
| A6 | E | | | | | | |
| Example | Compound | 0.5 | 1992 | 214 | 0.6 | 11 | 8 |
| A9 | E′ | | | | | | |
| Example | Compound | 0.5 | 1585 | 194 | 0.6 | 12 | 8 |
| A10 | H′ | | | | | | |

TABLE 8

| | | | Concentration | | | | Li⁺/all |
|---|---|---|---|---|---|---|---|
| | | Mixed solvent | of lithium salt | Iᵢₙᵢ | Iₗᵢₘ | Iₗᵢₘ/Iᵢₙᵢ | ions* |
| | Ionic liquid | (% by mass**) | (mol/kg) | (μA/cm²) | (μA/cm²) | (%) | (%) |
| Example | Compound | 25 | 0.4 | 912 | 255 | 28 | 8 |
| B1 | A | | | | | | |
| Example | Compound | 25 | 0.4 | 623 | 122 | 20 | 8 |
| B15 | A′ | | | | | | |
| Example | Compound | 25 | 0.4 | 633 | 138 | 22 | 9 |
| B2 | B | | | | | | |
| Example | Compound | 25 | 0.4 | 568 | 128 | 23 | 9 |
| B16 | B′ | | | | | | |
| Example | Compound | 25 | 0.65 | 478 | 132 | 28 | 14 |
| B3 | C | | | | | | |
| Example | Compound | 25 | 0.4 | 617 | 163 | 26 | 9 |
| B4 | D | | | | | | |
| Example | Compound | 25 | 0.4 | 353 | 97 | 27 | 9 |
| B5 | E | | | | | | |
| Example | Compound | 25 | 0.4 | 391 | 96 | 25 | 9 |
| B17 | E′ | | | | | | |
| Example | Compound | 25 | 0.4 | 264 | 80 | 30 | 9 |
| B18 | H′ | | | | | | |

The present invention includes the following exemplary embodiments [1] to [12].

[1]

A dicationic ionic liquid containing:
a cation having
   two moieties each containing a heteroatom having a positive formal charge, and
   a linking group bonding to each of the heteroatoms of the two moieties to link the two moieties,
in which the linking group is represented by a formula: —CR¹R²OCR³R⁴CR⁵R⁶OCR⁷R⁸—.

(In the formula, R¹ to R⁸ are each a hydrogen atom, a fluorine atom, or a monovalent organic group having 1 to 20 carbon atoms; the organic group is represented by a formula: —R^{A}—(X—R^{B})ₙ—R^{C}; R^{A} is a covalent bond or a substituted or unsubstituted divalent hydrocarbon group; X is —O—, —S—, —C(═O)—, —C(═O)O—, or —OC(═O)—; R^{B} is a covalent bond or a substituted or unsubstituted divalent hydrocarbon group; R^{C} is a substituted or unsubstituted monovalent hydrocarbon group; and n is 0 or more, provided that 4 or more of R¹ to R⁸ are hydrogen atoms.)

[2]

The ionic liquid according to [2], in which all of R¹ to R⁸ are hydrogen atoms.

[3]

The ionic liquid according to [1] or [2], in which the ionic liquid has a 10% weight loss temperature of 280° C. or higher when measured at a temperature rising rate of 5° C./minute.

[4]

The ionic liquid according to any one of [1] to [3], in which the two moieties have mutually different chemical structures.

[5]

An ionic liquid,
in which, when a composite electrolyte which contains the ionic liquid and a lithium salt and in which a concentration of the lithium salt is 0.5 mol/kg in terms of lithium ions is prepared, a ratio expressed by the following expression for the composite electrolyte at 25° C. is 10% or more.

Iₗᵢₘ/Iᵢₙᵢ Expression:

(In the expression, Iₗᵢₘ is a limiting current density of the composite electrolyte, and when a constant voltage is applied to the composite electrolyte at a voltage value at which a current density first reaches the limiting current density, Iᵢₙᵢ is a current density at 1 second after start of application of the constant voltage.)

[6]

The ionic liquid according to [6], in which the ionic liquid is a dicationic ionic liquid.

[7]

The ionic liquid according to any one of [1] to [6], in which an upper limit of a potential window of the ionic liquid is 2.0 V or more based on a Fc/Fc⁺ electrode standard, and an ionic conductivity at 25° C. is 0.1 S/cm or more.

[8]

A composite electrolyte containing: a lithium salt; and the ionic liquid according to any one of [1] to [7].

[9]

The composite electrolyte according to [8], further containing: a viscosity reducing agent.

[10]

A composite electrolyte containing: an ionic liquid; and a lithium salt,
in which a ratio expressed by the following expression is 20% or more.

Iₗᵢₘ/Iᵢₙᵢ Expression:

(In the expression, Iₗᵢₘ is a limiting current density, and is a current density when the current density is approximately constant for 1 hour or longer in a case where a current density value is measured while applying a constant voltage of 0.1 V to the composite electrolyte at 25° C.; and Iᵢₙᵢ is a current density at 1 second after start of application of a constant voltage of 0.1 V to the composite electrolyte.)

[11]

The composite electrolyte according to [10], in which a value of the limiting current density is 90 μA/cm² or more.

[12]

The composite electrolyte according to [10] or [11], in which the ionic liquid is a dicationic ionic liquid.

1. A dicationic ionic liquid comprising:
a cation having
two moieties each containing a heteroatom having a positive formal charge, and
a linking group bonding to each of the heteroatoms of the two moieties to link the two moieties,
wherein the linking group is represented by a formula: —CR¹R²OCR³R⁴CR⁵R⁶OCR⁷R⁸—,
(in the formula, R¹ to R⁸ are each a hydrogen atom, a fluorine atom, or a monovalent organic group having 1 to 20 carbon atoms; the organic group is represented by a formula: —R^{A}—(X—R^{B})ₙ—R^{C}; R^{A} is a covalent bond or a substituted or unsubstituted divalent hydrocarbon group; X is —O—, —S—, —C(═O)—, —C(═O)O—, or —OC(═O)—; R^{B} is a covalent bond or a substituted or unsubstituted divalent hydrocarbon group; R^{C} is a substituted or unsubstituted monovalent hydrocarbon group; and n is 0 or more, provided that 4 or more of R¹ to R⁸ are hydrogen atoms).

2. The ionic liquid according to claim 1, wherein all of R¹ to R⁸ are hydrogen atoms.

3. The ionic liquid according to claim 1, wherein the ionic liquid has a 10% weight loss temperature of 280° C. or higher when measured at a temperature rising rate of 5° C./minute.

4. The ionic liquid according to claim 1, wherein the two moieties have mutually different chemical structures.

5. An ionic liquid,
wherein, when a composite electrolyte which contains the ionic liquid and a lithium salt and in which a concentration of the lithium salt is 0.5 mol/kg in terms of lithium ions is prepared, a ratio expressed by the following expression for the composite electrolyte at 25° C. is 10% or more,
Iₗᵢₘ/Iᵢₙᵢ Expression:
(in the expression, Iₗᵢₘ is a limiting current density of the composite electrolyte, and when a constant voltage is applied to the composite electrolyte at a voltage value at which a current density first reaches the limiting current density, Iᵢₙᵢ is a current density at 1 second after start of application of the constant voltage).

6. The ionic liquid according to claim 5, wherein the ionic liquid is a dicationic ionic liquid.

7. The ionic liquid according to claim 1, wherein an upper limit of a potential window of the ionic liquid is 2.0 V or more based on a Fc/Fc⁺ electrode standard, and an ionic conductivity at 25° C. is 0.1 S/cm or more.

8. A composite electrolyte comprising:
a lithium salt; and
the ionic liquid according to claim 1.

9. The composite electrolyte according to claim 8, further comprising:
a viscosity reducing agent.

10. A composite electrolyte comprising:
an ionic liquid; and
a lithium salt,
wherein a ratio expressed by the following expression is 20% or more,
Iₗᵢₘ/Iᵢₙᵢ Expression:
(in the expression, Iₗᵢₘ is a limiting current density, and is a current density when the current density is approximately constant for 1 hour or longer in a case where a current density value is measured while applying a constant voltage of 0.1 V to the composite electrolyte at 25° C.; and Iᵢₙᵢ is a current density at 1 second after start of application of a constant voltage of 0.1 V to the composite electrolyte).

11. The composite electrolyte according to claim 10, wherein a value of the limiting current density is 90 μA/cm² or more.

12. The composite electrolyte according to claim 10, wherein the ionic liquid is a dicationic ionic liquid.

13. The ionic liquid according to claim 5, wherein an upper limit of a potential window of the ionic liquid is 2.0 V or more based on a Fc/Fc⁺ electrode standard, and an ionic conductivity at 25° C. is 0.1 S/cm or more.

14. A composite electrolyte comprising:
a lithium salt; and
the ionic liquid according to claim 5.

15. The composite electrolyte according to claim 11, wherein the ionic liquid is a dicationic ionic liquid.
